(19) United States
(12) Patent Application Publication
(10) Pub. No.: US 2019/0164099 A1
(43) Pub. Date: May 30, 2019

(54) SYSTEM AND METHOD FOR LIFE CYCLE OPERATION OF SUPPLY CHAIN BUSINESS TRANSACTION

(71) Applicant: SU-CC Corporation Limited, Yuen Long (HK)

(72) Inventor: Suk Yee Au Li, Kowloon (HK)

(21) Appl. No.: 16/199,042

(22) Filed: Nov. 23, 2018

Related U.S. Application Data
(63) Continuation of application No. 14/478,762, filed on Sep. 5, 2014, now abandoned.
Application No. 14/478,762 is a continuation-in-part of application No. 13/778,966, filed on Feb. 27, 2013, now abandoned.
(60) Provisional application No. 61/914,569, filed on Dec. 11, 2013.
(60) Provisional application No. 61/605,463, filed on Mar. 1, 2012.

(51) Int. Cl. G06Q 10/06; G06Q 40/02; G06Q 40/08

(52) U.S. Cl. CPC G06Q 10/06315; G06Q 40/08; G06Q 40/025

(57) ABSTRACT

A system for life cycle operation of a supply chain business transaction includes a system configured to record and store information regarding participants and products in a supply chain business transaction; a system configured to record and track products produced and consumed in a supply chain business transaction; a system configured to monitor contract performance and quality of products in a supply chain business transaction; a system configured to determine the amount of loan credit to be issued to the suppliers in a supply chain business transaction, and a system configured to determine the amount of insurance coverage to be issued to suppliers in a supply chain business transaction.

### FIELD

The embodiments hereby disclosed relate generally to a system for supply chain business transaction management, and a method to operate the same, and more specifically, a system for life cycle operation of a supply chain business transaction, and a method to operate the same.

### BACKGROUND

A supply chain is widely adopted in current marketplace to move a product from supplier to customer. Depending on the sophistication of the product manufacturing process, several parties including buyers and suppliers may be involved in a supply chain for the procurement of certain goods or products. Usually only one supplier (the top level supplier) contracts with a buyer to obtain a purchase order for certain goods or products. Subsequently the top level supplier usually contracts with another supplier or several suppliers for part of or the entire fulfillment of the purchase order. Therefore, the buyers and the suppliers from the top level to the lowest level form a supply chain business transaction.

Financial services providers (financial institutions) in general provide financings (loans) to their clients in the marketplace including buyers and suppliers in a supply chain, to facilitate working capital flows within the supply chain. Insurance providers in general provide insurances to their clients in the marketplace including buyers and suppliers in a supply chain to hedge risks associated with the product procurement processes.

In a supply chain in general there is substantial amount of information generated and circulated among relevant parties. A massive amount of information containing obsolete or incorrect information may cause confusions, mistakes and delays in the production process, therefore lowering the efficiency of the supply chain and causing unnecessary costs for the parties in the supply chain. Participants may collude to provide false or fraudulent papers to deceive financial services providers and insurance providers. Product quality and contract performance may not be under strict scrutiny when numerous participants are involved in the supply chain business transaction. Counterfeiting products may be produced and consumed in the manufacturing steps of the supply chain business transaction. Delays and defaults may cause disputes among participants, which may exacerbate when they have undergone undetected.

### SUMMARY

The embodiments hereby disclosed relate generally to a system for supply chain business transaction management, and a method to operate the same, and more specifically, a system for life cycle operation of a supply chain business transaction, and a method to operate the same. More specifically, some embodiments hereby disclosed relate to a system to record and store information regarding participants and products in a supply chain business transaction, and a method to operate the same. Some embodiments hereby disclosed relate to a system to record and track the products produced and consumed in a supply chain business transaction, and a method to operate the same. Some embodiments hereby disclosed relate to a system to monitor the contract performance and the quality of the products in a supply chain business transaction, and a method to operate the same. Some embodiments hereby disclosed relate to a system to determine the amount of loan credit to be issued to the suppliers in a supply chain business transaction, and a method to operate the same. Some embodiments hereby disclosed relate to a system to determine the amount of insurance coverage to be issued to the suppliers in a supply chain business transaction, and a method to operate the same.

### BRIEF DESCRIPTION OF THE DRAWINGS

The following is a brief explanation of embodiments herein using drawings and embodiments:

FIG. 1 is a block diagram of a system for life cycle operation of a supply chain business transaction;

FIG. 2 is a block diagram of a system for recording and storing information regarding participants and products in a supply chain business transaction.

FIG. 3 is a block diagram of a system for recording and tracking products produced and consumed in a supply chain business transaction.

FIG. 4 is a block diagram of a system for monitoring contract performance and quality of products in a supply chain business transaction.

FIG. 5 is a block diagram of a system for determining an amount of loan credit to be issued to the suppliers in a supply chain business transaction according to the gross profit margin of each supplier in the supply chain business transaction, and issuing loan approvals to the suppliers according to their gross profit margins in the supply chain business transaction.

FIG. 6 is a block diagram of a system for determining an amount of insurance coverage to be issued to suppliers in a supply chain business transaction according to the gross profit margin of each supplier in the supply chain business transaction, and issuing insurance approvals to the suppliers according to their gross profit margins in the supply chain business transaction.

FIG. 7 is a flow chart representing the steps to monitor contract performance and quality of products in a supply chain business transaction.

FIG. 8 is a flow chart representing the steps for life cycle operation of a supply chain business transaction.

### DETAILED DESCRIPTION

As used herein, the term “supply chain” refers to an organizational format of entities, people, activities, information, and resources involved in moving a product or service from supplier to buyer.

As used herein, the term “client” refers to a participant in a supply chain business transaction who makes a loan approval request to a loan issuing agency, or an insurance approval request to an insurance issuing agency.

As used herein, the term “buyer” refers to the persons or entities which make purchase order, receive the final product and make payment.

As used herein, the term “supplier” refers to persons or entities who participate in part in the production and movement of products in the supply chain.

As used herein, the term “purchaser” refers to persons or entities other than the buyer who acquire products other than final products from the suppliers in the supply chain/As used herein, the term “double-entry bookkeeping” refers to a method of bookkeeping in which every entry to an account for a supplier in the supply chain requires a corresponding and opposite entry to a different account for a purchaser in the same supply chain.

As used herein, the term “productivity score” refers to score determined in different steps during a supply chain business transaction, which may be used for monitoring, controlling and management purposes. Productivity score may have a full mark score, which may be deducted from time to time when problems occur in the supply chain business transaction. Productivity score positively correlates the performance in the supply chain business transaction.

Embodiments herein disclosed describe a system for life cycle operation of a supply chain business transaction, and a method to operate the system for life cycle operation of a supply chain business transaction.

### 1. Merchandising System 1000

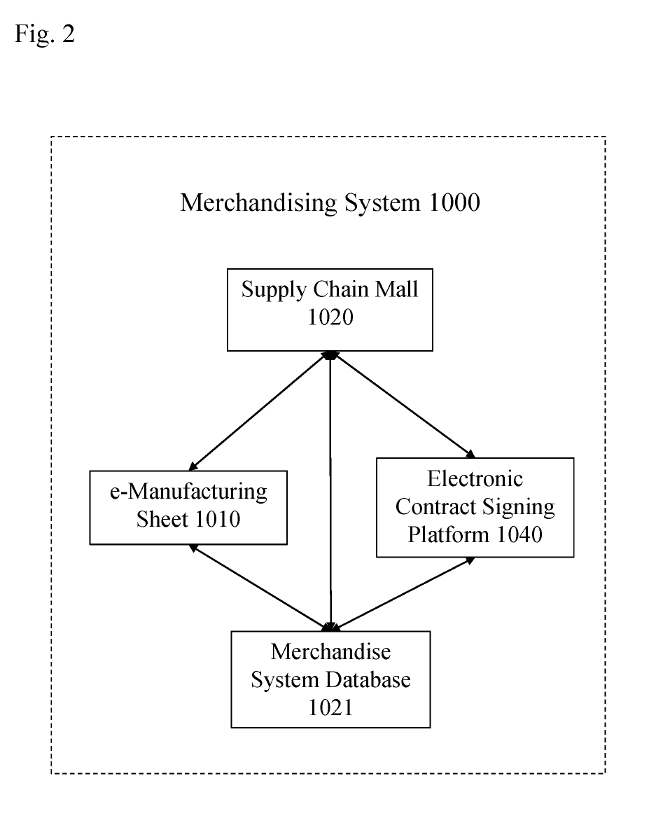

As shown in FIG. 2, a Merchandising System 1000 is provided to record and store information regarding participants and products in a supply chain business transaction.

In one embodiment the Merchandising System 1000 may operate with the Quality and Contract Control System 6000 to create e-Manufacturing Sheet 1010 for production, by converting sales contract to e-Manufacturing Sheet 1010. The Merchandising System 1000 may further process the e-Manufacturing Sheet 1010 and may make searches and inquiries, access information and calculate the budget for purchasing. The Merchandising System 1000 may further make a purchase from Supply Chain Mall 1020 by signing standardized contracts. By completing above steps, the Merchandising System 1000 may increase product quality control, prevent fraud for fake product, and prevent collusion between buyers and sellers.

### 1.1 Supply Chain Mall 1020

In one embodiment the Supply Chain Mall 1020 may include reliable suppliers coming from the Merchandising System 1000. The suppliers may have real trading history records in the Quality and Contract Control System 6000. The suppliers' records may include the history of manufacturing and trading goods, and may also include suppliers' capability of delivering quality goods. The information in the records may be traceable in the Product Tracking Report 1030.

In one embodiment the Supply Chain Mall 1020 is an electronic market place, which may display various products. The products may come from the Product Tracking System 2000 or the Merchandising System 1000. The Supply Chain Mall 1020 may assign a product item number to each of the products displayed in the Supply Chain Mall 1020. The product item number assigned may be unique to each of the products, to ensure the authenticity and reliability of the products. In some embodiments, the Supply Chain Mall 1020 may operate in a self-sufficient manner, which may require no additional suppliers or products. A self-sufficient Supply Chain Mall 1020 may help information disclosure among suppliers, secure payments among suppliers and ensure the reliability of products, therefore to reduce or eliminate counterfeit products or money laundering.

In one embodiment the Supply Chain Mall 1020 may designate a buyer who has a valid sales order or a confirmed letter of credit as a real buyer. In one embodiment the Supply Chain Mall 1020 may designate a supplier who has reliable product delivery capacity as a true supplier. The Supply Chain Mall 1020 may serve to facilitate the communication and negotiation between and/or among true buyers and true suppliers, by disclosure relevant information to both sides necessary for their business engagements. Therefore, the Supply Chain Mall 1020 may serve as a clearinghouse for true buyers and true suppliers, in which the buyers and suppliers may approach potential business partners in confidence even the deal is new to both sides. The Supply Chain Mall 1020 may reduce the transaction costs for true buyers and true suppliers, and may help to generate more profits for them.

In one embodiment the Supply Chain Mall 1020 may access to a variety of information of the products including the price and quality of the products from multiple suppliers. In one embodiment the information may be further stored and made accessible in the Merchandise System Database 1021. The Supply Chain Mall 1020 may process the information in an efficient manner, screening and selecting information which may be further analyzed or utilized. The Supply Chain Mall 1020 may serve as an efficient supply chain information warehouse, especially for products allocation storage information. The information may be made accessible to authorized users including suppliers or buyers in the Supply Chain Mall 1020. Further encryption methods may be used by the Supply Chain Mall 1020 to main the integrity as well as the confidentiality of the data.

The Supply Chain Mall 1020 may further integrate information of products, buyers and suppliers from the Product Tracking System 2000. The Supply Chain Mall 1020 may further update existing information from time to time by accessing the Product Tracking System 2000 for any updates of existing information. The Supply Chain Mall 1020 may secure the information procurement process and the updating process. In one embodiment the information may be further stored and made accessible in the merchandise system database 1021. The Supply Chain Mall 1020 therefore may further facilitate supply chain business transactions by providing up-to-date information of relevant products and suppliers. The Supply Chain Mall 1020 may accelerate the matching of suppliers on different levels to form a supply chain interlock contracts, and may reduce future fraud, default or dispute arising from the contracts.

1.2 e-Manufacturing Sheet 1010

In one embodiment, each supplier may have an e-Manufacturing Sheet 1010. The e-Manufacturing Sheet 1010 may be converted from the supplier's sales contract. The e-Manufacturing Sheet 1010 may also be converted from a buyer's purchase order. The e-Manufacturing Sheet 1010 may contain certain information including the product item number unique to each product, product category, materials used or to be used for manufacturing, accessories, size and color assortment, quantity, etc. In one embodiment the information may be further stored and made accessible in the Merchandise System Database 1021. The e-Manufacturing Sheet 1010 may use the information to shorten time required to develop production plan, and may ensure the required materials to be used in a proper manner.

In one embodiment, the e-Manufacturing Sheet 1010 may be configured to interact with the Supply Chain Mall 1020 directly. The e-Manufacturing Sheet 1010 may therefore view and select from a display of a variety of suppliers, the products of which may be used as materials in the supply chain business transaction. The e-Manufacturing Sheet 1010 may further operate through an e-procurement planning process, processing relevant information and calculating the costs of different products/supplier selections, and comparing the costs to the budgets in the supply chain business transactions. By accessing to the up-to-date information from the Supply Chain Mall 1020, the e-Manufacturing Sheet 1010 may configure the e-manufacturing planning precisely, and may make a selection of materials reflecting market trends.

In one embodiment, the e-Manufacturing Sheet 1010 may conduct the e-procurement planning process by further including data conversion process, procurement data comparison process and order placing process.

In one embodiment, the e-Manufacturing Sheet 1010 may conduct the data conversion process by acquiring product information from a variety of suppliers including prices, quality, past performance records, etc. from the Supply Chain Mall 1020. During the data conversion process, the information acquired may be displayed and reviewed by suppliers in the supply chain business transaction. The suppliers in the supply chain business transaction may proofread the information and make proper adjustments. The information may be further transmitted to the procurement data comparison process. The data conversion process may be configured to further speed up the data conversion speed, therefore to provide further efficiency when utilizing the e-Manufacturing Sheet 1010.

In one embodiment, the e-Manufacturing Sheet 1010 may conduct the procurement data comparison process by acquiring the information reviewed and proofread by the suppliers in the supply chain business transaction, and may compare the information from different product-supplier selections according to different factors and combinations thereof including quality, price, shipping date, terms, origin of products, etc. The procurement data comparison process may determine the selection of products/suppliers which may provide most profitability, reliability and time efficiency to the supply chain business transaction in a whole. The procurement data comparison process may make a selection on different targeted achievements or goals suitable for special purposes of a supply chain business transaction, which may be used for customized production or purposes unique to special circumstances. The procurement data comparison process may be configured to further speed up the procurement data comparison speed, therefore to provide further efficiency when utilizing the e-Manufacturing Sheet 1010.

In one embodiment, the e-Manufacturing Sheet 1010 may conduct order placing process by operating to place orders directly when the e-Manufacturing Sheet 1010 concludes the procurement data comparison process and makes selection of products/suppliers. The order placing process may further examine the orders placed at each level of the supply chain business transaction, to ensure the orders are in consistent with the credit/budget allocated to each level of the supply chain transaction. The order placing process therefore may prevent over purchasing on certain level of the supply chain business transaction.

In one embodiment, the e-Manufacturing Sheet 1010 may update the information when a contract is concluded between a supplier or purchaser in the e-Manufacturing Sheet 1010 and a supplier in the Supply Chain Mall 1020. When contracts are concluded on each level of the supply chain business transaction, the e-Manufacturing Sheet 1010 may be printed out, and may further be applied for production. If any of the contracts is not concluded by the due dates set forth in the e-Manufacturing Sheet 1010, the Alert system 6300 may send an alert to the supplier responsible for such contract, in order to prevent delay or default in the production process. In one embodiment, the e-Manufacturing Sheet 1010 may covert interlocking contracts into a contract chain when contracts are concluded on all levels of the supply chain business transaction. The e-Manufacturing Sheet 1010 may further confirm the status of contracts in the contract chain when the contracts are executed, and to coordinate the execution process. The e-Manufacturing Sheet 1010 may therefore reduce the chance of error in placing order and control product quality in the supply chain business transaction.

In one embodiment, the Supply Chain Mall 1020 may be configured to allow a start-up company to view and select from a display of a good amount of varieties of products and suppliers through the e-Manufacturing Sheet 1010 after submitting a confirmed letter of credit and opening a supply chain credit flow account. The Supply Chain Mall 1020 may provide the start-up company the opportunity to work with highly qualified suppliers in a supply chain, to better help the growth of the start-up company in the industry.

### 1.3 Electronic Contract Signing Platform 1040

In one embodiment, the Merchandising System 1000 may further include an Electronic Contract Signing Platform 1040. The Electronic Contract Signing Platform 1040 may adopt and prepare contracts to be used in the supply chain business transactions automatically with unified and standard terms. The Electronic Contract Signing Platform 1040 may provide suppliers/purchasers contracts with acceptance in relevant industry, therefore may help to reduce confusion, ambiguity and may provide more predictability in contract terms. The Electronic Contract Signing Platform 1040 may use contracts with generally accepted terms, which may be further executed, stored, and further accessed in an electronic, computer-readable and executable format. The Electronic Contract Signing Platform 1040 may furnish contracts which may be used in the Bank Capital Reserve Management System 4000 and the Insurance Reserve Management System 5000. When approved, the contracts may be used as collateral in supply chain credit flow system.

### 2. Product Tracking System 2000

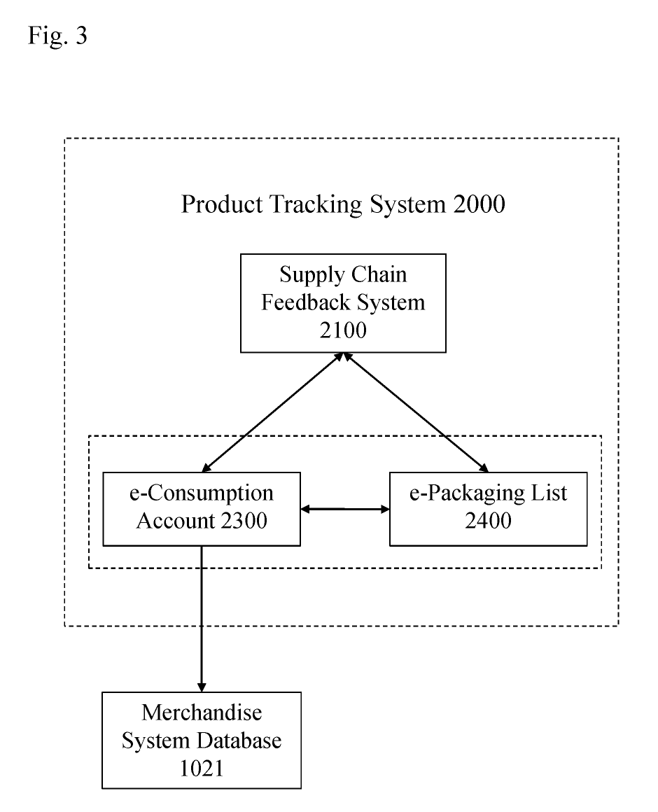

As shown in FIG. 3, a Product Tracking System 2000 is provided to record and track the products produced and consumed in a supply chain business transaction.

In one embodiment, a Product Tracking System 2000 may be configured to control raw material products which are used in production in all the levels in the supply chain business transaction, to ensure that the raw material products meet the manufacturing specification according to the e-Manufacturing Sheet 1010. The Product Tracking System 2000 may also monitor material products consumed and products produced in each level in the supply chain, which may enhance the quality of the products, and may also prevent fraud and control default. In one embodiment, the Product Tracking System 2000 may associate invoices from different levels of the supply chain. The Product Tracking System 2000 may trace the origins and destinations of the products. By linking up entire supply chain as a whole, the Product Tracking System 2000 may uncover suspicious or false invoice which may be used for money laundering or other illegal activities, even when such activates may not be readily detectable when viewed separately.

In one embodiment, the Product Tracking System 2000 may further include an e-Consumption Account 2300 and an e-Packaging List 2400. The e-Consumption Account 2300 and the e-Packaging List 2400 may be configured to record the data of product movement and consumption from a lower level in the supply chain to a higher level in the supply chain.

In one embodiment, the Product Tracking System 2000 is configured to perform routine checks on the transaction records of the suppliers to the supply chain business transaction, to detect potential fraud and/or defaults. If new production data is not found in an e-Consumption Account 2300 by due date, or if raw material is not deducted from the e-Consumption Account 2300, the Product Tracking System 2000 may indicate potential fraud and default. In one embodiment the Product Tracking System 2000 may notify relevant parties for follow up action. The Product Tracking System 2000 may also give warning signals to higher level supplier(s), which may allow higher level suppliers to negotiate with lower level supplier(s) or to replace lower level supplier(s) by other suppliers from the Supply Chain Mall 1020.

In one embodiment, the Product Tracking System 2000 may include a Supply Chain Feedback System 2100. The Supply Chain Feedback System 2100 may further collect feedback information regarding the nature of the unconformity, and the upper level supplier(s)' willingness to accept the delivery of the unconformed products by signing the invoice(s). The Supply Chain Feedback System 2100 may conduct the information collection process for the delivery of products by supplier(s) on each level of supply chain, and may process and store the information collected. In one embodiment, upon receipt of products from lower level supplier(s), the Supply Chain Feedback System 2100 may be configured to provide higher level supplier(s) information regarding the delivery of the products. The Supply Chain Feedback System 2100 may notify the higher level supplier(s) to check whether the products delivered meet the purchase specification in the e-Manufacturing Sheet 1010. The Supply Chain Feedback System 2100 may collect feedback information from upper level suppliers regarding unconformity found in the goods delivered. When a dispute materializes between or among suppliers in the supply chain business transaction regarding the products in the supply chain, the Supply Chain Feedback System 2100 may provide relevant information to facilitate evidence discovery and dispute settlement.

In one embodiment, the Supply Chain Feedback System 2100 may collect feedback information which reflects quality of the products. The feedback information may relate to the quality of products from raw materials at the lowest level of the supply chain, to intermediate products, and up to final products of the supplier at the top level of the supply chain. The Supply Chain Feedback System 2100 may compile the feedback information into a transaction log, which may be provided to and accessible by all parties to the supply chain business transaction. The transaction log may disclose any discrepancy in the supply chain business transaction, which may assist to monitor and enhance product quality, and may detect issues in an earlier stage and facilitate quick resolutions. The Supply Chain Feedback System 2100 may further reduce the chance and seriousness of dispute on final products between and among parties to the supply chain business transaction by ensuring the products(?) delivered at each level of the supply chain meet the purchase specification in the e-Manufacturing Sheet 1010. In one embodiment, Suppliers A, B and C are three suppliers in a supply chain business transaction. Supplier C is on the lower level of the supply chain. Supplier B is on the intermediate level of the supply chain. Supplier A is on the higher level of the supply chain. Supplier C produces lower level product, Product III, which serves as raw material for Supplier B to produce intermediate level product, Product II. Supplier A uses Product II to produce final product, Product I. Suppliers A, B and C enter their respective production data into the e-Consumption Account 2300.

In one embodiment, when Supplier C produces Product III, the Product Tracking System 2000 may extract Supplier C's data regarding Product III from the e-Consumption Account 2300, and may convert the data into Supplier C's data in the e-Packaging List 2400. In one embodiment, after conversion, Supplier C's data regarding Product III may be retracted if the data is converted into Supplier C's data in the e-Packaging List 2400. Supplier C's data in the e-Packaging List 2400 may be printed or otherwise displayed for checking and confirmation. In one embodiment, new data of Supplier C regarding Product III may be entered into the e-Consumption Account 2300 when Supplier C commences new production of Product III.

In one embodiment, when Supplier B receives and accepts Product III, Supplier C's data in the e-Packaging List 2400 regarding Product III may be completely converted into Supplier B's data regarding Product II, which may be further entered into the e-Consumption Account 2300. The Supply Chain Feedback System 2100 may collect feedback information which reflects quality of the Product III and the performance of Supplier C. Supplier B may put Product III into production for Product II according to the purchase specification in the e-Manufacturing Sheet 1010. In another embodiment, the Product Tracking System 2000 may further check the e-Consumption Account 2300 whether any information has yet converted from Supplier C's information regarding Product III into Supplier B's data regarding Product II, and may make conversion if such information exists.

In one embodiment, when Supplier B produces Product II, the Product Tracking System 2000 may extract Supplier B's data regarding Product II from the e-Consumption Account 2300, and may convert the data into Supplier B's data in the e-Packaging List 2400. In one embodiment, after conversion, Supplier B's data regarding Product II may be retracted if the data is converted into Supplier B's data in the e-Packaging List 2400, and further converted into supplier A's data in the e-Consumption Account 2300. Supplier B's data in the e-Packaging List 2400 may be printed or otherwise displayed for checking and confirmation. In one embodiment, new data of Supplier B regarding Product II may be entered into the e-Consumption Account 2300 when Supplier B commences new production of Product II.

In one embodiment, when Supplier A receives and accepts Product II, Supplier B's data in the e-Packaging List 2400 regarding Product II may be completely converted into Supplier A's data regarding Product I, which may be further entered into the e-Consumption Account 2300. The Supply Chain Feedback System 2100 may collect feedback information which reflects quality of the product B and the performance of Supplier B. Supplier A may put Product II into production for Product I according to the purchase specification in the e-Manufacturing Sheet 1010. In another embodiment, the Product Tracking System 2000 may further check the e-Consumption Account 2300 whether any information has yet converted from Supplier B's information regarding Product II into Supplier A's data regarding Product I, and may make conversion if such information exists.

In one embodiment, Supplier B may fail to deliver Product II conforming to the purchase specification in the e-Manufacturing Sheet 1010. In another embodiment, Supplier B may fail to deliver Product II by due date. The Supply Chain Feedback System 2100 may during its regular checks detect the failure of Supplier B to deliver conforming products, or to deliver products on time. The Supply Chain Feedback System 2100 may notify Supplier A of Supplier B's failure in performance, and may allow Supplier A ample to negotiate with Supplier B for solution, or to seek suppliers from the Supply Chain Mall 1020 to replace Supplier B. In one embodiment, Supplier B may fail to enter data regarding Product II into the e-Consumption Account 2300. The Supply Chain Feedback System 2100 may detect such missing in data entry, and may notify Supplier A of potential default or delay in delivery of Product II. In another embodiment, the Supply Chain Feedback System 2100 may conduct a precautionary check at a given time before the due date for the delivery of Product II in addition to its regular checks, to ensure the performance of Supplier B conforming to the purchase specification in the e-Manufacturing Sheet 1010 and to remind Supplier B of any remaining performance to be conducted in view of the approaching deadline.

In one embodiment, the Product Tracking System 2000 may record, store, convert and delete data rapidly in the e-Consumption Account 2300 and in the e-Packaging List 2400. The Product Tracking System 2000 may enhance product quality and may prevent breach of contract or fraud by monitoring products movement and consumption from the lowest level in the supply chain to the highest level of the supply chain.

### 3. Quality and Contract Control System 6000

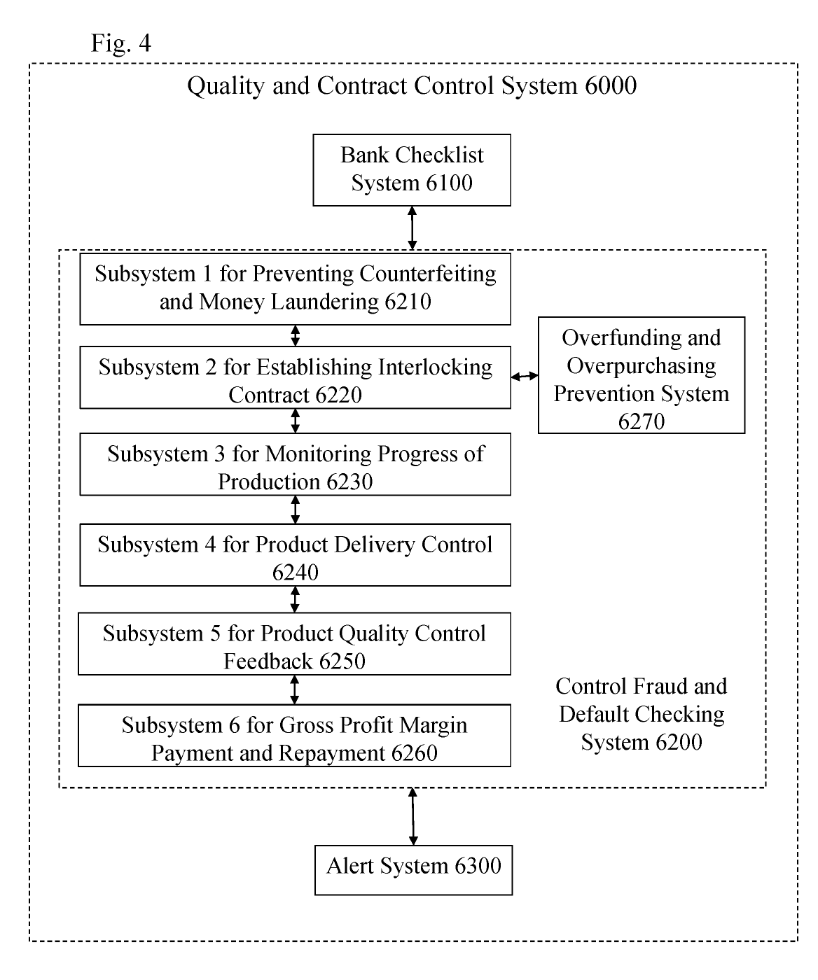

As shown in FIG. 4, a Quality and Contract Control System 6000 is provided to monitor the contract performance and the quality of the products in a supply chain business transaction. In one embodiment, the Quality and Contract Control System 6000 may include a Bank Checklist System 6100, a Control Fraud and Default Checking System 6200, and an Alert System 6300.

### 3.1 Bank Checklist System 6100

In one embodiment, the Bank Checklist System 6100 may include a Supply Chain Production Lead Time Calculator 6110 and a Preset Supply Chain Alert Due Date Calculator 6120 to calculate the critical dates in a supply chain transaction for quality and contract performance control purposes.

3.1.1 Supply Chain Production Lead Time Calculator 6110

Production lead time of the top level supplier's contract is calculated based on the production days of all suppliers in the supply chain business transaction. The production lead time of the top level supplier's contract equals to the total production days in the supply chain business transaction. Therefore, production lead time of a supplier equals to the production time of the supplier plus the production lead time of the supplier on the immediately lower level on the supply chain. It is also understood that the production time of a supplier equals to the production lead time of the suppliers minus the production lead time of the supplier on the immediately lower level on the supply chain. In one embodiment, the leftover time may be the number of days between expected shipment date of the top level supplier's contract and the last delivery date of the supplier at the lowest level. The Bank Checklist System 6100 may monitor the contracts in the supply chain which are interlocked into a contract chain. The Bank Checklist System 6100 may check the production time, production lead time and leftover time for different suppliers in the supply chain, and may oversee the progress of the supply chain business transaction with increased transparency and charity.

In one embodiment, the Supply Chain Production Lead Time Calculator 6110 may be configured to record and calculate the critical dates for a supply chain business transaction. In one embodiment, the Supply Chain Production Lead Time Calculator 6110 may record and calculate several critical dates for a supply chain having 5 levels, Levels A to E, with Suppliers A to E on corresponding level. In one embodiment, the Supply Chain Production Lead Time Calculator 6110 may record and calculate critical dates for a supply chain business transaction including sales order contract date (designated as “a”), production lead time (designated as “b”), production time (designated as “c”), shipment date as agreed (designated as “d”), actual shipment date (designated as “e”), payment date as agreed (designated as “f”), contract expiry date as agreed (designated as “g”), number of days for contract period (designated as “h”), guaranteed letter of credit at number of days sight, date for bank loan repayment as agreed (designated as “j”), and number of days for repayment. It is understood that the following correlations exist among the critical dates:

(a) production lead time equals to shipment date as agreed minus sales order contract date plus one (b=d−a+1);

(b) number of days for contract period equals to contract expiry date as agreed minus sales order contract date plus 1 (h=g−a+1);

(c) guaranteed letter of credit at number of days sight equals to payment date as agreed (f) minus shipment date as agreed (d);

(d) date for bank loan repayment as agreed equals to payment date as agreed plus 1 (j=f+1);

(e) number of days for repayment equals to date for bank loan repayment as agreed (j) minus sales order contract date (a); and

(f) the production time for a supplier in a certain level equals to the production lead time for such supplier minus the production lead time for the supplier immediate below such supplier (the production lead time for a supplier in the lowest level equals to the production lead time for such supplier),

In one embodiment, the Supply Chain Production Lead Time Calculator 6110 may record and calculate the critical dates in a supply chain business transaction as following, showing in Table 3.1.1.

TABLE 3.1.1
one embodiment for the Supply Chain Production Lead Time Calculator 6110
Supply Chain Production Lead Time Calculator

| | | | | | | | | | Number of | | | |
|---|---|---|---|---|---|---|---|---|---|---|---|---|
| | | Sales | Production | Produc- | | | | Contract | days for | guranteed | Date for | |
| Supply | | order | lead time | tion | Shipment | Actual | Payment | expiry | contract | letter of | bank loan | Number of |
| chain | | Contract | as agreed | time | date as | shipment | date as | date as | period | credit | repayment | date for |
| no. | | date | b = d − | c = bₙ − | agreed | date | agreed | agreed | h = g − | period | as agreed | repayment |
| 1 | Suppliers | a | a + 1 | bₙ₋₁ | d | e | f | g | a + 1 | f − d | j = f + 1 | j − a |
| | Supplier A | 1-Apr | 30 | 11 | 30-Apr | 30-Apr | 30-May | 2-Jun | 63 | 30 | 31-May | 60 |
| | Supplier B | 3-Apr | 19 | 7 | 21-Apr | 21-Apr | 30-May | 2-Jun | 61 | 39 | 31-May | 58 |
| | Supplier C | 5-Apr | 12 | 5 | 16-Apr | 16-Apr | 30-May | 2-Jun | 59 | 44 | 31-May | 56 |
| | Supplier D | 7-Apr | 7 | 4 | 13-Apr | 13-Apr | 30-May | 2-Jun | 57 | 47 | 31-May | 54 |
| | Supplier E | 9-Apr | 3 | 3 | 11-Apr | 11-Apr | 30-May | 2-Jun | 55 | 49 | 31-May | 52 |
| | Total | | | 30 | | | | | | | | |

3.1.2 Preset Supply Chain Alert Due Date Calculator 6120

In one embodiment, the Preset Supply Chain Alert Due Date Calculator 6120 may record and calculate the dates on which alert may be sent to supplier and other parties to a supply chain business transaction. In one embodiment, the alert dates may be grouped as: alert dates for making purchase (designated as “b”), leftover time for making purchases (designated as “c”), alert dates for inputting product data (designated as “d”), leftover time for inputting product data (designated as “e”), alert dates for shipment (designated as “f”), leftover time for product delivery (designated as “g”), alert dates for feedback (designated as “h”), alert dates for purchaser to sign back invoice (designated as “i”), alert dates for payment and repayment (designated as “j”), and leftover days for payment and repayment (designated as “k”). In one embodiment, the Preset Supply Chain Alert Due Date Calculator 6120 may record the date as of today, and may designate it as “a”. In one embodiment, the alert dates for making purchase may be 2 days after singing the supply chain contracts. In one embodiment, the alert dates for inputting product data may be at the 70% of a period of production time after materials for production have been received. In one embodiment, the alert dates for shipment may be 2 days before shipment. In one embodiment, the alert dates for feedback may be 7 days after shipment. In one embodiment, the alert dates for purchaser to sign back invoice may be 10 days after shipment. In one embodiment, the alert dates for payment and repayment may be set by the supply chain contracts. It is understood that the following correlations exist among the critical dates:

(a) the leftover time for making purchase equals to the date as of today minus the alert date for making purchases;

(b) the leftover time for inputting product data equals to the date as of today minus the alert date for inputting product data;

(c) the leftover time for product delivery equals to the expected shipment date minus the date as of today; and

(d) the leftover time for payment and repayment equals to the alert date for payment and repayment minus the date as of today.

In one embodiment, the date as of today is April 22, and the expected shipping date is May 30. The Preset Supply Chain Alert Due Date Calculator 6120 may record and calculate the dates on which alert may be sent to supplier and other parties to a supply chain business transaction as following, showing in Table 3.1.2.

TABLE 3.1.2
one embodiment for the Preset Supply Chain Alert Due Date Calculator 6120
Preset Supply Chain Alert Due Date Calculator

| | | | Purchase | | Product data input | | Shipment |
|---|---|---|---|---|---|---|---|
| | | | Preset alert due date | | Preset alert due date (assume: | | Preset alert due |
| Contract Chain | | | (assume: 2 days | Leftover time | at the 70% of a period of production | Leftover time | date (assume: 2 |
| Supply | | date of | after contract signing) | for making | time after materials received) | of product data | days before shipment) |
| Chain | | today | b = contract | purchase | d = material receive + | input | f = shipment |
| number | Suppliers | a | date + 2 | c = a − b | 70% of production time | e = a − d | date − 2 |
| 1 | Supplier A | 22-Apr | 3-Apr | −19 | 26-Apr | 4 | 28-Apr |
| | Supplier B | | 5-Apr | −17 | 18-Apr | −4 | 19-Apr |
| | Supplier C | | 7-Apr | −15 | 14-Apr | −8 | 14-Apr |
| | Supplier D | | 9-Apr | −13 | 11-Apr | −11 | 11-Apr |
| | Supplier E | | 11-Apr | −11 | 10-Apr | −12 | 10-Apr |

| | | | | Purchaser Sign | | |
|---|---|---|---|---|---|---|
| | | Shipment | Feedback | back invoice | | |
| | | Leftover time | Preset alert due | Preset alert due | Payment & Repayment | |
| Contract Chain | | of product | date (assume: 7 | date (assume: 10 | Alert due date | |
| Supply | | delivery (days) | days after shipment) | days after shipment) | (according to | Leftover |
| Chain | | g = expected | h = actual | l = actual | contract) | time |
| number | Suppliers | shipment date − a | shipment date + 7 | shipment date + 10 | j | k = j − a |
| 1 | Supplier A | 8 | 7-May | 10-May | 30-May | 38 |
| | Supplier B | −1 | 28-Apr | 1-May | 30-May | 38 |
| | Supplier C | −6 | 23-Apr | 26-Apr | 30-May | 38 |
| | Supplier D | −9 | 20-Apr | 23-Apr | 30-May | 38 |
| | Supplier E | −11 | 18-Apr | 21-Apr | 30-May | 38 |

### 3.2 Control Fraud and Default Checking System 6200

In one embodiment, the Control Fraud and Default Checking System 6200 may interact with the Preset Supply Chain Alert Due Date Calculator 6120, access the preset dates from the Preset Supply Chain Alert Due Date Calculator 6120, and utilize the preset dates to carry out its fraud and default control and check function.

In one embodiment, the Control Fraud and Default Checking System 6200 may include a Subsystem 1 for Preventing Counterfeiting and Money Laundering 6210, a Subsystem 2 for Establishing Interlocking Contract 6220, a Subsystem 3 for Monitoring Progress of Production 6230, a Subsystem 4 for Product Delivery Control 6240, a Subsystem 5 for Product Quality Control Feedback 6250, and a Subsystem 6 for Gross Profit Margin Payment and Repayment 6260.

In one embodiment, the Control Fraud and Default Checking System 6200 may calculate the Productivity Scores 0100 for each of the subsystems. In one embodiment, the Productivity Scores 0100 may help to perceive the potential fraud and default rapidly among hundreds of contract by indicating such in numbers. In one embodiment, the Productivity Score 0100 may help to create controlling date which determines what kind of solution may be used for different situation. In one embodiment, the Productivity Score 0100 may measure the capability of supplier for contract implementation. In one embodiment, the Productivity Score 0100 may be converted into probability of default, which may measure the possibility of success in the supply chain business transaction.

In one embodiment, the Control Fraud and Default Checking System 6200 may further include an Overfunding and Overpurchasing Prevention System 6270.

3.2.1 Subsystem 1 for Preventing Counterfeiting and Money Laundering 6210

In one embodiment, the Subsystem 1 for Preventing Counterfeiting and Money Laundering 6210 may include a Contract Condition Evaluation Calculator 6211 and a Contract Authentication Calculator 6212.

In one embodiment, the Contract Condition Evaluation Calculator 6211 may be configured to examine and check the confirmed letter of credit for credit allowances and allocation among the suppliers in the supply chain. In another embodiment, the Contract Condition Evaluation Calculator 6211 may be configured to examine and check the interlocking contract, which may be contracts related directly and indirectly to buyer's purchase order. The Contract Condition Evaluation Calculator 6211 may ensure repayment security by examine the content of the confirmed letter of credit or the interlocking contract. The Contract Condition Evaluation Calculator 6211 may assign a score after evaluating the confirmed letter of credit or the interlocking contract. A higher score may indicate that the contract condition for the supply chain business transaction is good, and risk from the contract condition is low.

In one embodiment, the Contract Condition Evaluation Calculator 6211 may be configured to examine and evaluate suppliers' production capability and the purchaser's sales distribution. In one embodiment, the Contract Condition Evaluation Calculator 6211 may use suppliers' and purchaser's historical record from the Supply Chain Mall 1020, forming an average historical Productivity Score 0100 for each supplier and purchaser. A higher score may indicate that the suppliers and purchasers have a stronger history in successful performance, and may indicate the supply chain business transaction contract is authentic as oppose to a fraudulent contract used for money laundering.

In one embodiment, the Contract Authentication Calculator 6212 may be configured to match product in the supply chain business transaction and to perform quality control.

In one embodiment, the Contract Authentication Calculator 6212 may extract information from purchaser's purchase order for matching product. The information extracted may include product item number unique to each of the products in the Supply Chain Mall 1020, product description for the products. The Contract Authentication Calculator 6212 may access the Supply Chain Mall 1020 to match information in the Supply Chain Mall 1020. In one embodiment, when the product item number and the product description are not current in the Supply Chain Mall 1020, the Contract Authentication Calculator 6212 may be configured to create new product item number and product description for the product. By matching the products required in the supply chain business transaction contract with the products in the Supply Chain Mall 1020, the Contract Authentication Calculator 6212 may ensure the authenticity of the products to be used, and may prevent counterfeiting products or products of inferior quality.

In one embodiment, the Subsystem 1 for Preventing Counterfeiting and Money Laundering 6210 may further be configured to calculate the score for the estimate of the productivity of the contract based on the information acquired. In one embodiment, the Subsystem 1 for Preventing Counterfeiting and Money Laundering 6210 may calculate the score according to the following, as shown in Table 3.2.1.

TABLE 3.2.1
one embodiment for the Subsystem 1
for Preventing Counterfeiting and Money Laundering 6210

| | Subsystem 1 for Prevent Counterfeiting and Money Laundering | | | | |
|---|---|---|---|---|---|
| | | Score estimate of productivity | | | |
| | | score for each | weight in | | |
| | (full mark for the contract completed successfully: 100) | item | proportion | score | status |
| Step | Description | a | b | a × b | indicator |
| | contract condition evaluation calculator | | | | |
| 1 | Confirmed L/C (or interlocking contract) on payment security | 100 | 50% | 50 | pass |
| 2 | Supplier's production capability (based on average historical | 90 | 10% | 9 | pass |
| | productivity score) | | | | |
| 3 | Purchaser's sales distribution (based on average historical productivity | 80 | 10% | 8 | pass |
| | score) | | | | |
| | contract authentication calculator | | | | |
| 4 | Product Matching - Product reliability score | 75 | 30% | 22.5 | pass |
| | Total score for the estimate of the productivity of contract | 86 | 100% | 90 | pass |

In the above embodiment, the productivity score is result of score for each item (a) multiplied by the weight in portion (b) of that item. The total productivity score is sum of productivity scores of all the items.

3.2.2 Subsystem 2 for Establishing Interlocking Contract 6220

In one embodiment, the Subsystem 2 for Establishing Interlocking Contract 6220 may be configured to set up control mechanism for purchasing, which may authorize loan approval agencies to net-off account receivable and account payable, and to further protect the rights of the loan approval agencies.

In one embodiment, the Subsystem 2 for Establishing Interlocking Contract 6220 may communicate with the Merchandising System 1000, and may access the information on the e-Manufacturing Sheet 1010, to check for the date of loan application.

In one embodiment, the Subsystem 2 for Establishing Interlocking Contract 6220 may access the Subsystem 1 for Preventing Counterfeiting and Money Laundering 6210 to acquire the total productivity score for the estimate of the productivity of contract of Subsystem 1.

In one embodiment, the Subsystem 2 for Establishing Interlocking Contract 6220 may access the Overfunding and Overpurchasing Prevention System 6270 to check for the total amount of purchasing in the supply chain business transaction. In one embodiment, the amount of total placing purchase order may be divided by sales contract, the result of which represents the total amount of purchasing.

In one embodiment, the Subsystem 2 for Establishing Interlocking Contract 6220 may communicate with the Bank Capital Reserve Management System 4000 to check the date of gross profit margin loan approval.

In one embodiment, the Subsystem 2 for Establishing Interlocking Contract 6220 may communicate with the Insurance Reserve Management System 5000 to check the date of gross profit margin insurance approval.

In one embodiment, the Subsystem 2 for Establishing Interlocking Contract 6220 may further be configured to calculate the score for the formation of interlocking contract based on the information acquired. In one embodiment, the subsystem 2 for Establishing Interlocking Contract may calculate the score for the formation of interlocking contract according to the following, as shown in Table 3.2.2.

TABLE 3.2.2
one embodiment for the Subsystem 2 for Establishing Interlocking Contract 6220

| | | preset alert due | | | | Production leftover time | | Score estimate for productivity | | | |
|---|---|---|---|---|---|---|---|---|---|---|---|
| | | date | | | | after due date | | | | | probability |
| | | day(s) | preset | Cnmpletion | | total days | number of | | | | of fraud |
| | Subsystem 2 for | after | due date | date | overdue | e = | point for | score for | | | & default |
| | Establishing | contract | b = | (date of | day | production | each day | each item | weight in | score | risk |
| | Interlocking | signing | contract | pass) | d = | lead time − | f − full | g = 100 − | proportion | j = | k = 100% − |
| Step | Contract | a | date + a | c | c − b | a − 1 | mark: 100/e | f × d | h | g × h | j/100 |
| 5 | accessing the | 2 | 3-Apr | 3-Apr | 0 | 27 | 4 | 100 | 20% | 20 | |
| | merchandising system: | | | | | | | | | | |
| | check for the date | | | | | | | | | | |
| | of loan application | | | | | | | | | | |
| 6 | score from Subsystem | | | | | | | 90 | 20% | 18 | |
| | 1 for Preventing | | | | | | | | | | |
| | Counterfeiting | | | | | | | | | | |
| | and Money Laundering | | | | | | | | | | |
| 7 | access the overfunding | total amount of placing | | | 65% | | (65% × | 72 | 20% | 14 | |
| | and overpurchasing | purchase order in % | | | | | 100/90%) = | | | | |
| | prevention calculator | | | | | | 72 | | | | |
| | to check for the total | | | | | | | | | | |
| | amount of purchasing | | | | | | | | | | |
| 8 | Loan approval system - | 2 | 3-Apr | 3-Apr | 0 | 27 | 4 | 100 | 20% | 20 | |
| | checking on the date | | | | | | | | | | |
| | of gross profit margin | | | | | | | | | | |
| | loan approval | | | | | | | | | | |
| 9 | Insurance underwriting | 2 | 3-Apr | 3-Apr | 0 | 27 | 4 | 100 | 20% | 20 | |
| | approval system - | | | | | | | | | | |
| | checking on the date | | | | | | | | | | |
| | of gross profit margin | | | | | | | | | | |
| | insurance approval | | | | | | | | | | |

| | | | | |
|---|---|---|---|---|
| Total score for the formation of interlocking contract | 87 | 100% | 92 | 8% |

pass

In the above embodiment, the preset due date (b) is determined by adding days after contract signing (a) to contract date. Overdue days (d) equal to completion date (c) over preset due date (b). Total days (e) equal to production lead time minus a minus 1. Number of points for each day (f) equals to full mark of pointed divided by e. Productivity score for each item (g) equals to full mark of points subtracted by the result of f multiplied by d. Weight in proportion (h) is assigned for each item. Total score is calculated by adding the result (j) of h×g together. The probability of fraud and default equals to 100% minus the result (j) of h×g divided by 100.

3.2.3 Subsystem 3 for Monitoring Progress of Production 6230

In one embodiment, the Subsystem 3 for Monitoring Progress of Production 6230 may be configured for early detection and resolution on potential delay or default in production, fraud, and breach of contract, which may enhance prevention of commercial dispute

In one embodiment, the Subsystem 3 for Monitoring Progress of Production 6230 may communicate with the Product Tracking System 2000, and may access the material data in the e-Consumption Account 2300. The Subsystem 3 for Monitoring Progress of Production 6230 may check the date of input of the material data in the e-Consumption Account 2300.

In one embodiment, the Subsystem 3 for Monitoring Progress of Production 6230 may communicate with the Product Tracking System 2000, and may access the material data in the e-Consumption Account 2300. The Subsystem 3 for Monitoring Progress of Production 6230 may record the date of signature in order to track the progress of production.

In one embodiment, the Subsystem 3 for Monitoring Progress of Production 6230 may access the product data input into the e-Consumption Account 2300 in the Product Tracking System 2000, and check the date of input of such data.

In one embodiment, the Subsystem 3 for Monitoring Progress of Production 6230 may further be configured to calculate the score for progress of production based on the information acquired. In one embodiment, the Subsystem 3 for Monitoring Progress of Production 6230 may calculate the score for progress of production according to the following, as shown in Table 3.2.3.

In the above embodiment, the preset due date (b) is determined by adding days after cargo received as agreed (a) to cargo receipt date. Overdue days (d) equal to completion date (c) over preset due date (b). Total days (e) equal to production time minus a. Number of points for each day (f) equals to full mark of pointed divided by e. Productivity score for each item (g) equals to full mark of points subtracted by the result of f multiplied by d. Weight in proportion (h) is assigned for each item. Total score is calculated by adding the result (j) of h×g together. The probability of fraud and default equals to 100% minus the result (j) of h×g divided by 100.

TABLE 3.2.3
one embodiment for the Subsystem 3 for Monitoring Progress of Production 6230

| | | Preset alert due date | | | | Production leftover | | | | | |
|---|---|---|---|---|---|---|---|---|---|---|---|
| | | calculator 8 | | | | time after due date | | Score for Productivity | | | |
| | | day(s) | | | | | Number of | | | | Probability |
| | | after | Preset due | | | days of | point for | | | | of fraud |
| | Subsystem 3 for | cargo | date | | overdue | total | each day | Score for | | | & default |
| | Monitoring | received | b = cargo | Completion | day | e = | f − | each item | weight in | score | risk |
| | Progress of | as agreed | receipt | date | d = | production | full mark: | g = 100 − | proportion | j = | k = 100% − |
| Step | Production | a | date + a | c | c − b | time − a | 100/e | f × d | h | g × h | j/100 |
| 10 | access the | 2 | 23-Apr | 24-Apr | 1 | 9 | 11 | 89 | 20% | 18 | |
| | product tracking | | | | | | | | | | |
| | system for | | | | | | | | | | |
| | material data | | | | | | | | | | |
| | input into | | | | | | | | | | |
| | e-consumption | | | | | | | | | | |
| | account; check | | | | | | | | | | |
| | the date of input | | | | | | | | | | |
| 11 | monitor signing | 3 | 24-Apr | 24-Apr | 0 | 8 | 13 | 100 | 20% | 20 | |
| | of the purchasing | | | | | | | | | | |
| | invoice returned | | | | | | | | | | |
| | to seller; check | | | | | | | | | | |
| | the date of | | | | | | | | | | |
| | signature | | | | | | | | | | |
| | | (days) | b = | | | Production | | | | | |
| | | before | expected | | | leftover | | | | | |
| | | shipment as | shipment | | | time as | | | | | |
| | | agreed | date − e | | | agreed | | | | | |
| 12 | Product data input | 4 | 26-Apr | 27-Apr | 1 | 4 | 25 | 75 | 60% | 45 | |
| | into e-consumption | | | | | | | | | | |
| | account: check the | | | | | | | | | | |
| | date of input | | | | | | | | | | |

| | | | | |
|---|---|---|---|---|
| Total score for progress of production | 88 | 100% | 83 | 17% |

pass

3.2.4 Subsystem 4 for Product Delivery Control 6240

In one embodiment, the Subsystem 4 for Product Delivery Control 6240 may be configured to prevent false bills of lading, fake invoices, packing lists and other risks that often appear during product delivery.

In one embodiment, the Subsystem 4 for Product Delivery Control 6240 may communicate with the Product Tracking System 2000, access the e-Packaging List 2400 output from e-Consumption Account 2300 to buyer, and check for the date of output

In one embodiment, the Subsystem 4 for Product Delivery Control 6240 may monitor the standardized invoice with data sent to the purchaser, and check the date of sending.

In one embodiment, the Subsystem 4 for Product Delivery Control 6240 may communicate with the Contract Authentication Calculator 6212 and check if the invoice is reliable.

In one embodiment, the Subsystem 4 for Product Delivery Control 6240 may monitor the signed invoice received by purchaser, and check for the date of receipt.

In one embodiment, the Subsystem 4 for Product Delivery Control 6240 may further be configured to calculate the score for product delivery control based on the information acquired. In one embodiment, the Subsystem 4 for Product Delivery Control 6240 may calculate the score for product delivery control based on the information acquired according to the following, as shown in Table 3.2.4.

TABLE 3.2.4
one embodiment for the Subsystem 4 for Product Delivery Control 6240

| | | preset alert due | | | | Production leftover time | | | | | |
|---|---|---|---|---|---|---|---|---|---|---|---|
| | | date | | | | after due date | | Score estimate for productivity | | | |
| | | | Preset due | | | | Number of | Score | | | Probability |
| | Subsystem 4 | (days) | date | | | | point for | for each | | | of fraud |
| | Calculator | before | b = | | overdue | | each day | item full | | | & default |
| | for Product | shipment as | expected | Completion | day | days of | f − | mark 100 | weight in | score | risk |
| | Delivery | agreed | shipment | date | d = | total | full mark: | g = 100 − | proportion | j = | k = 100% − |
| Step | Control | a | date − a | c | c − b | e = a | 100/e | f × d | h | g × h | j/100 |
| 13 | Product tracking | 2 | 28-Apr | 29-Apr | 1 | 2 | 50 | 50 | 45% | 23 | |
| | system: e-packing | | | | | | | | | | |
| | list output from | | | | | | | | | | |
| | e-consumption | | | | | | | | | | |
| | account to buyer - | | | | | | | | | | |
| | check for the | | | | | | | | | | |
| | date of output | | | | | | | | | | |
| | | | | | | leftover | | | | | |
| | | day(s) after | b = | | | time before | | | | | |
| | | actual | actual | | | payment (30 | | | | | |
| | | shipment as | shipment | | | days at | | | | | |
| | | agreed | date + a | | | sight/3 − a) | | | | | |
| 14 | Send Standardized | 2 | 2-May | 2-May | 0 | 8 | 13 | 100 | 10% | 10 | |
| | Invoice with data | | | | | | | | | | |
| | to the purchaser - | | | | | | | | | | |
| | check the date of | | | | | | | | | | |
| | sending | | | | | | | | | | |
| | Assume: preset due | | | | | | | | | | |
| | date in 2 days for | | | | | | | | | | |
| | presenting invoice | | | | | | | | | | |
| | to the purchaser | | | | | | | | | | |
| | after actual | | | | | | | | | | |
| | shipment, but not | | | | | | | | | | |
| | later than 8 days, | | | | | | | | | | |
| | (if it is 30 days | | | | | | | | | | |
| | at sight, not later | | | | | | | | | | |
| | than ⅓ period in | | | | | | | | | | |
| | credit, i.e. 30 | | | | | | | | | | |
| | days × ⅓ = | | | | | | | | | | |
| | 10 days, preset the | | | | | | | | | | |
| | leftover time before | | | | | | | | | | |
| | payment: 30 − | | | | | | | | | | |
| | 20 − 2 = 8 days) | | | | | | | | | | |
| 15 | Check if the invoice | | | | | | | 90 | 15% | 14 | |
| | is reliable by | | | | | | | | | | |
| | authentication | | | | | | | | | | |
| | calculator | | | | | | | | | | |
| | | | | | | leftover | | | | | |
| | | | | | | time before | | | | | |
| | | | | | | payment (30 | | | | | |
| | | | | | | days at | | | | | |
| | | | | | | sight/3 − a) | | | | | |
| 16 | Received the signed | 5 | 5-May | 8-May | 3 | 10 | 10 | 70 | 35% | 25 | |
| | invoice from | | | | | | | | | | |
| | purchaser (or | | | | | | | | | | |
| | buyer) - check for | | | | | | | | | | |
| | the date of receipt | | | | | | | | | | |

| | | | | |
|---|---|---|---|---|
| Total score for product delivery control | 73 | 105% | 71 | 30% |

In the above embodiment, the preset due date (b) is determined by subtracting days before payment as agreed (a) from expected payment date. Overdue days (d) equal to completion date (c) over preset due date (b). Total days (e) equal to a. Number of points for each day (f) equals to full mark of pointed divided by e. Productivity score for each item (g) equals to full mark of points subtracted by the result of f multiplied by d. Weight in proportion (h) is assigned for each item. Total score is calculated by adding the result (j) of h×g together. The probability of fraud and default equals to 100% minus the result (j) of h×g divided by 100.

3.2.5 Subsystem 5 for Product Quality Control Feedback 6250

In one embodiment, the Subsystem 5 for Product Quality Control Feedback 6250 may be configured to monitor the specification of the product, to conduct product matching and to make sure there is no chance of deception or counterfeiting. In one embodiment, when there is dispute between or among the suppliers and the purchasers, the Subsystem 5 for Product Quality Control Feedback 6250 may allocate the responsibilities between or among the disputing parties. In one embodiment, the Subsystem 5 for Product Quality Control Feedback 6250 may send complaints to supplier, performing the acts on behalf of the purchaser. In one embodiment, the Subsystem 5 for Product Quality Control Feedback 6250 may record the events and the number of occurrences that lead to the purchaser's complaint, including when there is no input feedback before invoice is signed, number of minor mistake in supplier's performance, number of major mistake in supplier's performance, and whether there is product rejection or payment withholding.

In one embodiment, the Subsystem 5 for Product Quality Control Feedback 6250 may send complaints to purchaser, performing the acts on behalf of the supplier. In one embodiment, the Subsystem 5 for Product Quality Control Feedback 6250 may record the events and the number of occurrences that lead to the supplier's complaint, including when there is no input feedback before invoice is signed, number of minor mistake in purchaser's performance, number of major mistake in purchaser's performance, and whether there is product rejection or payment withholding.

In one embodiment, the Subsystem 5 for Product Quality Control Feedback 6250 may further be configured to calculate the score for product quality control feedback based on the information acquired. In one embodiment, the Subsystem 5 for Product Quality Control Feedback 6250 may calculate the score for product quality control feedback based on the information acquired according to the following, as shown in Table 3.2.5.

TABLE 3.2.5
one embodiment for the Subsystem 5 for Product Quality Control Feedback 6250

| | | | | | | Score for Productivity | | |
|---|---|---|---|---|---|---|---|---|
| | | | | | | Score for each item | | |
| | | | Number of | | Total | (feedback to supplier | | |
| | | Number of | points deducted | Original | number of | and from buyer | | |
| | | mistake | for each | full | points | respectively) | weight in | |
| | Subsystem 5 for Product Quality Control | occurred | mistake | mark | deducted | e = c − | proportion | |
| Step | Feedback | a | b | c = 100 | d = a × b | sum of d | f | g = e × f |
| 17 | Send complaints to supplier | | | 100 | | | | |
| | No Input feedback before invoice signed | 0 | | | | | | |
| | Number of minor mistake | 5 | 5 | | 25 | | | |
| | Number of major mistake | 0 | 15 | | 0 | 75 | 80% | 60 |
| | either Product rejected or payment withheld | | | | 0 | | | |
| 18 | Send complaints to purchaser | | | 100 | | | | |
| | No Input feedback before invoice signed | 0 | | | | | | |
| | Number of minor mistake | 2 | 5 | | 10 | | | |
| | Number of major mistake | 1 | 15 | | 15 | 75 | 20% | 15 |
| | either Product rejected or payment withheld | | | | 0 | | | |

| | | | |
|---|---|---|---|
| Total score for product quality control feeback | 150 | 100% | 75 |

In the above embodiment, total number of points deducted (d) equals to number of mistakes occurred (a) multiplied by number of points deducted for each mistake (b). Productivity score for each item (e) is the result of full mark score (100) subtracted by the total of d. The weight in proportion (f) is assigned for each item, and the total score is calculated by adding the result of e×f together.

3.2.6 Subsystem 6 for Gross Profit Margin Payment and Repayment 6260

In one embodiment, the Subsystem 6 for Gross Profit Margin Payment and Repayment 6260 may be configured to exert complete control on money liquidity in the supply chain business transaction, and to eliminate collusion between suppliers and purchasers to conduct joint fraudulent conducts.

In one embodiment, the Subsystem 6 for Gross Profit Margin Payment and Repayment 6260 may interact with the Bank Capital Reserve Management System 4000, to access data regarding the signed invoice which are converted to interlocking accounts receivable, and check for the date of input of such data.

In one embodiment, the Subsystem 6 for Gross Profit Margin Payment and Repayment 6260 may interact with the Bank Capital Reserve Management System 4000, to access data regarding operating net-off procedure (i.e. the procedure to performance account receivable minus account payable) by which business dispute is resolved, and to check for the date of input of such data.

In one embodiment, the Subsystem 6 for Gross Profit Margin Payment and Repayment 6260 may interact with the Bank Capital Reserve Management System 4000, to access data regarding the purchaser making payment, and to check for the date of input of such data.

In one embodiment, the Subsystem 6 for Gross Profit Margin Payment and Repayment 6260 may interact with the Bank Capital Reserve Management System 4000, to access data regarding gross profit margin payment for supplier and repayment to bank, and to check for the date of input of such data.

In one embodiment, the Subsystem 6 for Gross Profit Margin Payment and Repayment 6260 may further be configured to calculate the score for gross profit margin payment and repayment based on the information acquired. In one embodiment, the Subsystem 6 for Gross Profit Margin Payment and Repayment 6260 may calculate the score for gross profit margin payment and repayment based on the information acquired according to the following, as shown in Table 3.2.6

TABLE 3.2.6
one embodiment for the Subsystem 6 for Gross Profit Margin Payment and Repayment 6260

| | | Preset alert due | | | | Payment leftover time | | Score for | | | |
|---|---|---|---|---|---|---|---|---|---|---|---|
| | | date | | | | after due date | | Productivity | | | |
| | | | Preset due | | | | Number of | score for | | | |
| | | day(s) | date | | | | point for | each item | | | |
| | Subsystem 6 for | before | b = | | overdue | | each day | (full mark | | | |
| | Gross Profit | payment | expected | Completion | day | total | f − full | 100) | weight in | | Probability |
| | Margin Payment | as agreed | payment | date | d = | days | mark/ | g = 100 − | proportion | | of fraud |
| Step | and Repayment | a | date − a | c | c − b | e = a | e 100 | f × d | h | | & default |
| 19 | Bank capital | 15 | 15-May | 15-May | 0 | 15 | 7 | 100 | 15% | j= h xg | k = 100% − |
| | reserve management | | | | | | | | | | j/100 |
| | system: Signed | | | | | | | | | | |
| | invoice converted | | | | | | | | | | |
| | to Interlocking | | | | | | | | | | |
| | receivable - | | | | | | | | | | |
| | check for | | | | | | | | | | |
| 20 | Bank capital | 3 | 27-May | 27-May | 0 | 3 | 33 | 100 | 30% | | |
| | reserve management | | | | | | | | | | |
| | system: operate | | | | | | | | | | |
| | net- | | | | | | | | | | |
| | | day(s) | | | | | | | | | |
| | | after | | | | Allowing | | | | | |
| | | payment | | | | delay | | | | | |
| | | date as | | | | payment | | | | | |
| | | agreed | | | | after due | | | | 15 | |
| 21 | Bank capital | 1 | 31-May | 31-May | 0 | 7 | 14 | 100 | 30% | 30 | |
| | reserve management | | | | | | | | | | |
| | system: Buyer make | | | | | | | | | | |
| | payment - check | | | | | | | | | | |
| | for the date of | | | | | | | | | | |
| | input | | | | | | | | | | |
| 22 | Bank capital | 1 | 31-May | 31-May | 0 | 7 | 14 | 100 | 25% | 30 | |
| | reserve management | | | | | | | | | | |
| | system: gross | | | | | | | | | | |
| | profit margin | | | | | | | | | | |
| | payment for | | | | | | | | | | |
| | supplier and | | | | | | | | | | |
| | repayment to bank - | | | | | | | | | | |
| | check for the date | | | | | | | | | | |
| | of input | | | | | | | | | | |
| | | | | | | | | 100 | 100% | 25 | |

| | | |
|---|---|---|
| Total score for gross profit margin payment and repayment | 100 | 0% |

In the above embodiment, the preset due date (b) is determined by subtracting days before payment as agreed (a) from expected payment date. Overdue days (d) equal to completion date (c) over preset due date (b). Total days (e) equal to a. Number of points for each day (f) equals to full mark of pointed divided by e. Productivity score for each item (g) equals to full mark of points subtracted by the result of f multiplied by d. Weight in proportion (h) is assigned for each item. Total score is calculated by adding the result (j) of h×g together. The probability of fraud and default equals to 100% minus the result (j) of h×g divided by 100.

3.2.7 Overfunding and Overpurchasing Prevention System 6270

In one embodiment, the Overfunding and Overpurchasing Prevention System 6270 may be configured to calculate the purchase amount made in a supply chain business transaction, in relation to the sales contract amount. The Overfunding and Overpurchasing Prevention System 6270 may display a total purchase amount percentage indicating the result from the total purchase amount divided by the total sales contract amount. In one embodiment, the Overfunding and Overpurchasing Prevention System 6270 may indicate to the parties (related?) to the supply chain business transaction when the total purchase amount percentage falls in a preset numerical range. In one embodiment, the numerical range may be categorized in different groups. In one embodiment, the groups may be further identified by assigning different color indicator to each of the groups. In one embodiment, the Overfunding and Overpurchasing Prevention System 6270 may be configured to calculate the total purchase amount percentage and display color indicator as following, shown in Table 3.2.7.

TABLE 3.2.7
one embodiment for theOverfunding and Overpurchasing Prevention System 6270

| | Estimated total | | | | | | | | |
|---|---|---|---|---|---|---|---|---|---|
| | purchase amount | | | Overfunding and | | Total purchase | | | |
| | in % as agreed, | | Total | overpurchasing | | amount | | Number of | |
| Sales | it will be | Total | purchase | prevention system | | calculated is | Total | point for | |
| order | changed subject | purchasing | amount in | Assume: full mark | | within the | purchase | each % | Productivity |
| amount | to final | amount | percentage | for total purchase | | following group | amount in % | d = | Score |
| a | confirmation | b | c | to sales order: 90% | Indicator | c | default | 100/90% | c × d |
| 1000 | 65% | 650 | 65% | Calculate: Amount of | green | 65% | 65%-90% | 111 | 72 |
| | | | | total purchasing divided | | | | | |
| | | | | by sales contract result | | | | | |
| | | | | within 65%-90% | | | | | |
| | | | | Calculate: Amount of | yellow | | 36%-64% | | |
| | | | | total purchasing divided | | | | | |
| | | | | by sales contract result | | | | | |
| | | | | within 36%-64% | | | | | |
| | | | | Calculate: Amount of | orange | | 10%-35% | | |
| | | | | total purchasing divided | | | | | |
| | | | | by sales contract result | | | | | |
| | | | | within 10%-35% | | | | | |
| | | | | Calculate: Amount of | red | | 0%-9% | | |
| | | | | total purchasing divided | | | | | |
| | | | | by sales contract result | | | | | |
| | | | | within 0%-9%, | | | | | |
| | | | | 91%-100% | | | | | |
| | | | | | | | 91%-100% | | |

In the above embodiment, the total purchasing amount (b) is divided by the sales order amount (a), and comes to the total purchase amount in percentage (c). When c is within 65%-90%, a green signal shows up. When c is within 36%-64%, a yellow signal shows up. When c is within 10%-35%, an orange signal shows up. When c is over 90% or below 10%, a red signal shows up. Number of points for each 1% equals to 100/90=111. The productivity score equals to c multiplied by b, and multiplied by 100.

### 3.3 Alert System 6300

In one embodiment, the Alert System 6300 may interact with the Supply Chain Production Lead Time Calculator 6110, and may acquire the preset dates in the supply chain transaction for calculation the alert due dates.

In one embodiment, the Alert System 6300 may be configured to set up an Alert Signal Checklist 6310. In one embodiment, the Alert Signal Checklist 6310 may include the follow steps:

331. when a purchaser makes a purchase order, the Alert System 6300 sends out a Purchasing Alert Signal 6301 on a purchasing alert due date. A Pass signal is sent out if the purchase is made properly and is recorded on the Product Tracking Report 1030. A No signal is sent out to suppliers for potential fraud and default prevention, if the purchase is not proper, or there is overpurchasing or overfunding;

332. when a new contract is signed, the Alert System 6300 sends out an Authentication Alert Signal 6302. A Pass signal is sent out if the contract is authentic, allowing suppliers to submit the contract to request gross profit margin loan approvals. A No signal is sent out if the contract is not authentic. In one embodiment, the Alert System 6300 may access the e-Manufacturing Sheet 1010 and the e-Consumption Account 2300 for relevant data including product item number, supplier's ID and description, etc. to authenticate the contract;

333. when there is product production data input into the merchandizing system, the Alert System 6300 sends out a Consumption Alert Signal 6303 on a consumption alert due date. A Pass signal is sent out if the production is in progress and is recorded on the Product Tracking Report 1030. A No signal is sent out if the production is not in progress, alerting purchaser for potential fraud and default prevention, to negotiate with the suppliers or to look for substitute suppliers from the Supply Chain Mall 1020.

334. when product is delivered, the Alert System 6300 sends out a Shipment Alert Signal 6304 on a shipment alert due date. A Pass signal is sent out if the contract is performed and is recorded on the Product Tracking Report 1030. A No signal is sent out if the contract is not performed, alerting purchaser and upper level suppliers for potential fraud and default prevention, to negotiate with the suppliers or to look for substitute suppliers from the Supply Chain Mall 1020.

335. when product quality conforms to the contract, the Alert System 6300 sends out a Feedback Alert Signal 6305 on a feedback alert due date. A Pass signal is sent out if the product quality conforms to the contract, allowing suppliers to ask for payment. A No signal is sent out if the product quality does not conform to the contract, alerting purchaser and suppliers to negotiate in view of potential commercial dispute.

336. when the invoice is signed back, the Alert System 6300 sends out an Invoice Alert Signal 6306 on an invoice alert due date. A Pass signal is sent out if the invoice is signed back and the purchaser commits payment. A No signal is sent out if the invoice is not signed back, alerting purchaser and upper level suppliers for potential fraud and default prevention, to negotiate with the suppliers or to look for substitute suppliers from the Supply Chain Mall 1020.

337. when there is newly signed invoice received, the Alert System 6300 sends out a Newly Signed Invoice Alert Signal 6307. A Pass signal is sent out if the newly signed invoice is authentic, and the newly signed invoice may be processed as account receivable. A No signal is sent out if the newly signed invoice is not authentic. In one embodiment, the Alert System 6300 may access the e-Manufacturing Sheet 1010 the e-Consumption Account 2300 for relevant data including product item number, supplier's ID and description, etc. to authenticate the newly signed invoice.

338. when the payment is received, the Alert System 6300 sends out a Payment Alert Signal 6308 on a payment alert due date. A Pass signal is sent out if the payment is properly made, and suppliers in the supply may be notified of the payment and the supply chain business transaction may be closed. A No signal is sent out if the payment is not received, notifying the suppliers to move for insurance coverage.

In one embodiment, the Alert System 6300 may identify suppliers who are in default in performance or have underperformance in the supply chain business transaction. The Alert System 6300 may send out alert signals to purchasers, other suppliers and interested parties to the supply chain business transaction, notifying them about the default or underperformance. The Alert System 6300 may seek substitutes from the Supply Chain Mall 1020 to substitute the supplier who has committed default or who has underperformed. In one embodiment, the Alert System 6300 may notify the Bank Capital Reserve Management System 4000 and the Insurance Reserve Management System 5000 of the occurrence of a supplier's default or underperformance, allowing the Bank Capital Reserve Management System 4000 and the Insurance Reserve Management System 5000 to downgrade their evaluation toward the supplier's creditworthiness.

In one embodiment, the Alert System 6300 may include a Risk Management System 6320. In one embodiment, when the Alert System 6300 sends out a No signal in one of the steps in the Alert Signal Checklist 6310, the No signal may be transmitted to the Risk Management System 6320 automatically. The Risk Management System 6320 may decipher the No signal, and analyze the information relevant to the No signal. The Risk Management System 6320 may provide risk management strategies according to the information relevant to the No signal, and may provide the risk management strategies to relevant parties including purchasers, suppliers, loan approval agencies and insurance agencies, etc.

In one embodiment, the Alert System 6300 may calculate the Productivity Score 0100 for the activities in the supply chain business transaction, and may send out indicator with various colors according to the score to notify relevant parties to the supply chain business transaction. In one embodiment, the indicator with various colors may be used to alert delay in the supply chain business transaction. In one embodiment, when the supply chain business transaction is completed before due date, the Productivity Score 0100 is 100, and the Alert System 6300 sends out an indicator with green light indicating the status of the supply chain business transaction is on time, and allow the supply chain business transaction to move forward into next steps. The production score diminishes as the number of days over the due date increases. When there is delay in the supply chain business transaction and the due date is past, the Alert System 6300 sends out an indicator with yellow light indicating a delay, and may notify relevant parties of the delay. When there is further delay, and the production score diminishes below 60, the Alert System 6300 sends out an indicator with orange light indicating a substantial delay, and may notify relevant parties of potential default. When there is further ongoing delay, and the production score diminishes below 20, the Alert System 6300 sends out an indicator with red light indicating a severe delay, and may notify relevant parties to prepare for immediate default. In one embodiment, when delay occurs, the Alert System 6300 also direct with the Risk Management System 6320 to provide risk management strategies to relevant parties to prevent dispute and mitigate damages.

In one embodiment, the Alert System 6300 may communicate with the Control Fraud and Default Checking System 6200, to provide alert signals according to the Productivity Score 0100 in the subsystems of the quality control system. The Alert System 6300 may acquire preset numerical ranges of the Productivity Scores 0100 from a certain subsystem, and may assign indicators with different colors according to the numerical ranges, in order to notify relevant parties of the occurrence of a certain event, or the seriousness of default, fraud, counterfeiting, money laundering or other activities that may breach the supply chain business transaction contract.

### 3.4 Operation of the Quality and Contract Control System 6000

In one embodiment, the Quality and Contract Control System 6000 may operate in 6 procedure groups covering 23 control checkpoints. Each procedure group includes certain steps and correlates with a subsystem. The Quality and Contract Control System 6000 may go through each checkpoint one by one, calculating of control fraud and default checking. If problem is discovered in one of the checkpoints, the Quality and Contract Control System 6000 may solve the problem before proceeding to the next checkpoint. In one embodiment, the Quality and Contract Control System 6000 may generate a Quality and Contract Control Report 6800 of the supply chain business transaction, for record keeping and evidentiary purposes. During the operation, probability of breach of contract diminishes through checkpoint one by one. In one embodiment, there is 100% probability of delay and default for each supplier to conduct his contract at the beginning, and then the probability becomes zero by going through the last checkpoint.

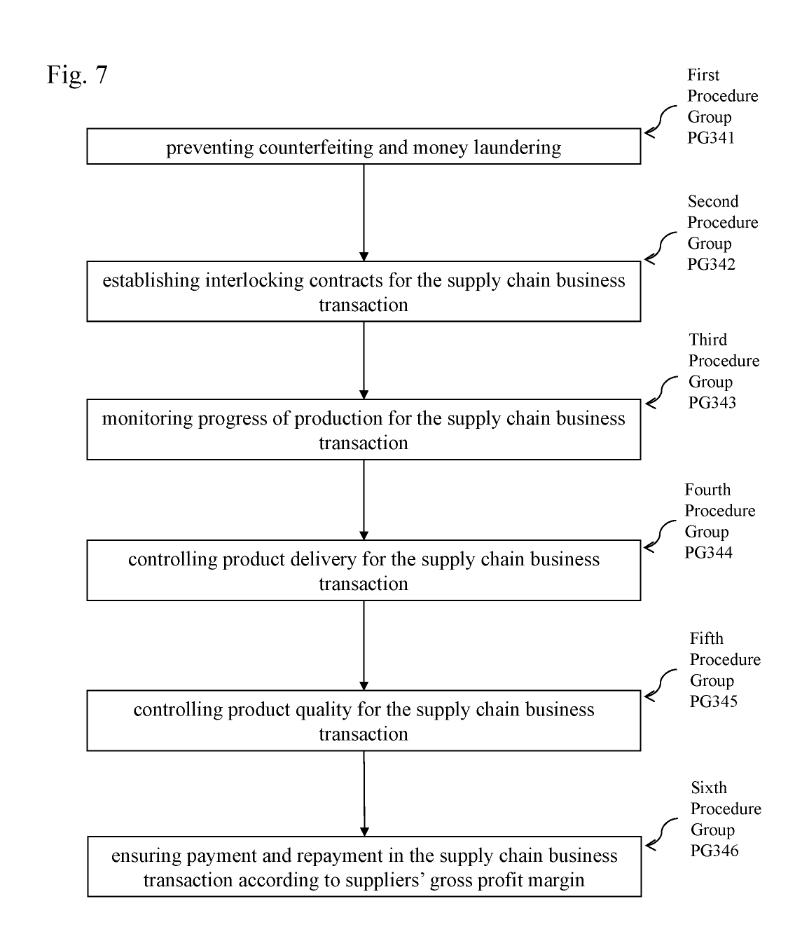

As further illustrated in FIG. 7, in one embodiment several steps are provided to operate the Quality and Contract Control System 6000, which may include:

3.4.1 the First Procedure Group PG 341 (Prevent Counterfeiting and Money Laundering in the Supply Chain Business Transaction)

The first procedure group correlates to the Subsystem 1 for Preventing Counterfeiting and Money Laundering 6210, including the following checkpoints:

341. examine the confirmed letter of credit at the top level of the supply chain or the interlocking contract related directly and indirectly to the buyer's purchase order, to ensure payment security;

342. examine suppliers' production capability by reviewing their average historical Productivity Score 0100 from the Supply Chain Mall 1020;

343. examine the purchaser's sales distribution by reviewing their average historical Productivity Score 0100 from the Supply Chain Mall 1020;

344. examine the authenticity of the contract by conducting product matching; and

345. evaluate the supplier's productivity by averaging last two historical records.

3.4.2 the Second Procedure Group PG 342 (Establish Interlocking Contract for the Supply Chain Business Transaction)

The second procedure group correlates to the Subsystem 2 for Establishing Interlocking Contract 6220, including the following checkpoints:

346. communicate with the Merchandising System 1000, and access the information on the e-Manufacturing Sheet 1010, to check for the date of loan application;

347. access the Subsystem 1 for Preventing Counterfeiting and Money Laundering 6210 to acquire the total score for the estimate of the productivity of contract of Subsystem 1;

348. access the Overfunding and Overpurchasing Prevention System 6270 to check for the total amount of purchasing in the supply chain business transaction;

349. communicate with the Bank Capital Reserve Management System 4000 to check the date of gross profit margin loan approval; and

3410. communicate with the Insurance Reserve Management System 5000 to check the date of gross profit margin insurance approval.

3.4.3 the Third Procedure Group PG 343 (Monitor the Progress of Production for the Supply Chain Business Transaction)

The third procedure group correlates to the Subsystem 3 for Monitoring Progress of Production 6230, including the following checkpoints:

3411. communicate with the Product Tracking System 2000, and may access the material data in the e-Consumption Account 2300, check the date of input of the material data in the e-Consumption Account 2300;

3412. communicate with the Product Tracking System 2000, and may access the material data in the e-Consumption Account 2300, record the date of signature of signed back invoice; and

3413. access the product data input into the e-Consumption Account 2300 in the Product Tracking System 2000, and check the date of input of such data.

3.4.4 the Fourth Procedure Group PG 344 (Control Product Delivery for the Supply Chain Business Transaction)

The fourth procedure group correlates to the Subsystem 4 for Product Delivery Control 6240, including the following checkpoints:

3414. communicate with the Product Tracking System 2000, access the e-Packaging List 2400 output from e-Consumption Account 2300 to buyer, and check for the date of output;

3415. monitor the standardized invoice with data sent to the purchaser, and check the date of sending;

3416. communicate with the Contract Authentication Calculator 6212 and check if the invoice is reliable; and

3417. monitor the signed invoice received by purchaser, and check for the date of receipt.

3.4.5 the Fifth Procedure Group PG 345 (Control Product Quality for the Supply Chain Business Transaction)

The fifth procedure group correlates to the Subsystem 5 for Product Quality Control Feedback 6250, including the following checkpoints:

3418. send complaints to the supplier, performing the acts on behalf of the purchaser, and record the events and the number of occurrences that lead to the purchaser's complaint, including when there is no input feedback before invoice is signed, number of minor mistakes in supplier's performance, number of major mistakes in supplier's performance, and whether there is product rejection or payment withholding; and

3419. send complaints to purchaser, performing the acts on behalf of the supplier, and record the events and the number of occurrences that lead to the supplier's complaint, including no input feedback before invoice is signed, number of minor mistakes in purchaser's performance, number of major mistakes in purchaser's performance, and whether there is product rejection or payment withholding.

3.4.6 the Sixth Procedure Group PG 346 (Ensure Payment and Repayment in the Supply Chain Business Transaction According to Suppliers' Gross Profit Margin)

The sixth procedure group correlates to the Subsystem 6 for Gross Profit Margin Payment and Repayment 6260, including the following checkpoints:

3420. interact with the Bank Capital Reserve Management System 4000, to access data regarding the signed invoices which are converted to interlocking accounts receivable, and check for the date of input of such data;

3421. interact with the Bank Capital Reserve Management System 4000, to access data regarding operating net-off procedure (i.e. the procedure to performance account receivable minus account payable) by which business dispute is resolved, and to check for the date of input of such data;

3422. interact with the Bank Capital Reserve Management System 4000, to access data regarding the buyer's making payment, and to check for the date of input of such data; and

3423. interact with the Bank Capital Reserve Management System 4000, to access data regarding gross profit margin payment for supplier and repayment to bank, and to check for the date of input of such data.

### 4. Bank Capital Reserve Management System 4000

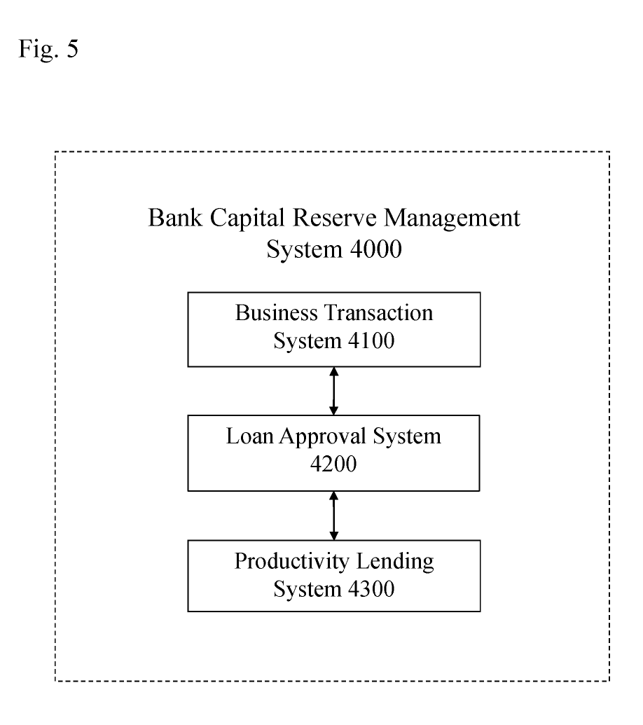

As shown in FIG. 5, a Bank Capital Reserve Management System 4000 is provided to determine the amount of loan credit to be issued to the suppliers in a supply chain business transaction according to the gross profit margin of each supplier in the supply chain business transaction, and to issue loan approvals to the suppliers according to their gross profit margins in the supply chain business transaction.

In one embodiment, the Bank Capital Reserve Management System 4000 may include a Business Transaction System 4100 to calculate the amount of sales order and purchase order (i.e. account receivable and account payable) for each of the suppliers in the supply chain business transaction. The Business Transaction System 4100 may calculate the amount of sales order and purchase order according to the interlocking contract for the supply chain business transaction, and may record the preset dates from the Quality and Contract Control System 6000.

In one embodiment, the Bank Capital Reserve Management System 4000 may include a Loan Approval System 4200 to calculate the amount of loan to be approved to the suppliers according to their gross profit margin in the supply chain business transaction. In one embodiment, the Loan Approval System 4200 may further calculate the interest to be charged for the loan assurance according to a preset interest rate or to a parameter from which interest rate may be calculated from time to time. In one embodiment, the Loan Approval System 4200 may further calculate the service charge to be charged for the loan assurance according to a preset service charge rate or to a parameter from which service charge rate may be calculated from time to time. The service fee charge may be made against the total contract amount (i.e. the amount of account payable plus the account receivable), in order to boost loan issuing agency's revenue. In one embodiment, the Loan Approval System 4200 may show the balance for each supplier after the gross profit of the supplier is deducted by the loan readily approved, loan issuing agency interest charge and service fee charge.

In one embodiment, the Bank Capital Reserve Management System 4000 may include a Productivity Lending System 4300 to calculate the total business turnover in the supply chain business transaction, and may also calculate the business turnover rate in the supply chain business transaction.

In one embodiment, the Bank Capital Reserve Management System 4000 may operate according to the following parameters, as shown in Table 4.1.

TABLE 4.1
one embodiment for the Bank Capital Reserve Management System 4000
Bank Capital Reserve Management system

| | | | | | | Loan approval system | | |
|---|---|---|---|---|---|---|---|---|
| | | Business Transaction System | | | | | | Balance of |
| | | | Buyer's | | | | | credit line |
| | Supply chain | | purchase order | | | Credit line for | Gross Profit | available in |
| | (including | Date of | with confirmed | Sales | Purchase | the entire | Margin | the entire |
| | numbers of | time | letter of credit | order | order | supply chain | financing | supply chain |
| Level | contract chains) | April | a | b | c | d | e | f |
| | Buyer | 1 | 1000 | | | 1000 | | |
| 1 | Supplier A | 1 | | 1000 | 650 | | 350 | 650 |
| 2 | Supplier B | 3 | | 650 | 490 | | 160 | 490 |
| 3 | Supplier C | 5 | | 490 | 390 | | 100 | 390 |
| 4 | Supplier D | 7 | | 390 | 0 | | 390 | 0 |
| | Total | | 1000 | 2530 | 1530 | 1000 | 1000 | 0 |

| | Loan approval system | | | | | |
|---|---|---|---|---|---|---|
| | | Bank | Service | | Productivity Lending System | |
| | | interest | Charge | Balance will be | | Total transaction as |
| | | (rate = 7%) | (rate = 7%) | deposited in | Accumulated | multiples of buyer's |
| | Bank loan | h | i | each supplier | total transaction | purchase order |
| | to supplier | e × 7% | (b + c) × 7% | account | (Turnover) | (turnover rate) |
| | on hand | Assume | | j | k | l |
| Level | g | 7% | 7% | e − g − h − i | b + c + k | k/a |
| | | | | | 1000 | 1 |
| 1 | 210 | 24.5 | 115.5 | 0 | 2650 | 2.65 |
| 2 | 69 | 11.2 | 79.8 | 0 | 3790 | 3.79 |
| 3 | 31 | 7 | 61.6 | 0.4 | 4670 | 4.67 |
| 4 | 335 | 27.3 | 27.3 | 0.4 | 5060 | 5.06 |
| | 645 | 70 | 284.2 | 0.8 | 5060 | 5.06 |

It is to be understood that following correlations further exist in the Bank Capital Reserve Management System 4000:

(1) buyer's purchase order amount (a) equals to credit line amount for the supply chain (d);

a supplier's purchase order amount (c) equals to the sales order amount (b) of supplier of a lower level cₙ=bₙ₋₁

(2) the amount of gross profit (e) equals to sales order amount (b) minus purchase order amount (c);

(3) the balance of credit line available in the supply chain (f) equals to purchase order amount (c);

(4) interest charge from bank h=e×interest rate (in the above embodiment, assuming 7%);

(5) service charge from bank i=(b+c)×service charge rate (in the above embodiment, assuming 7%);

(6) each supplier's balance j=e−g−h−i (g is bank loan approved for the supplier); and

(7) accumulated total business transaction turnover kₙ=bₙ+cₙ+kₙ₋₁.

In one embodiment, the Bank Capital Reserve Management System 4000 may contact with the buyer's bank for repayment on a preset determined payment date according to the purchase order for the supply chain business transaction. The amount of repayment required by the Bank Capital Reserve Management System 4000 from the buyer's bank may equal to the total amount of the gross profit margins of all the suppliers in the supply chain business transaction.

In one embodiment, the Bank Capital Reserve Management System 4000 may perform net-off function by making the calculation that the supply chain receivable amount minus supply chain payable, and use such amount as a basis for the interlocking contract and interlocking invoice existed in double-entry bookkeeping. In one embodiment, the Bank Capital Reserve Management System 4000 may collect the whole payment amount from the buyer and then distribute the payment to every supplier according to the gross profit margin in a supply chain, therefore may ensure the payment is guaranteed.

In another embodiment, the Bank Capital Reserve Management System 4000 may operate according to the following parameters and request for repayment from buyer's bank, as shown in Table 4.2.

TABLE 4.2
anotherembodiment for the Bank Capital Reserve Management System 4000
Repayment - Bank Capital Reserve Management system

| | | | | | | | | Cash flow on Payment date | | | |
|---|---|---|---|---|---|---|---|---|---|---|---|
| | | | | | Gross | | | Payment to all | | | |
| | | | | | Profit | Buyer's bank pays full | | suppliers in | | | Balance to |
| | Supply chain | | | | margin | amount of the contract | | gross profit | Supplier's | Interest | individual |
| | (including | | Account | Account | account | value (invoice amount) | | margin | loan on | & service | supplier |
| | numbers of | Shipping | receivable | payable | receivable | Date of | Payment | receivable | hand | charge | account |
| Level | contract chains) | date | a | b | c = a − b | Payment | amount | d = c | e | f | g = d − e − f |
| | Buyer's purchase | | | | | 30-May | 1,000 | | | | |
| | order (1,000k) | | | | | | | | | | |
| 1 | Supplier A | 30-Apr | 1000 | 650 | 350 | | | 350 | 210 | 140 | 0.0 |
| 2 | Supplier B | 21-Apr | 650 | 490 | 160 | | | 160 | 69 | 91 | 0.0 |
| 3 | Supplier C | 16-Apr | 490 | 390 | 100 | | | 100 | 31 | 69 | 0.4 |
| 4 | Supplier D | 13-Apr | 390 | 0 | 390 | | | 390 | 335 | 55 | 0.4 |
| | Total amount for | | 2530 | 1,530 | 1000 | | | | 645 | 354 | 0.8 |
| | supply chain | | | | | | | | | | |

It is to be understood that following correlations further exist in the above embodiment (1) a supplier's account payable amount (b) equals to the account receivable amount (a) of supplier of a lower level bₙ=aₙ₋₁

(2) the amount of gross profit c=a−b;

(3) payment to a supplier d=c;

(3) the balance of credit line available in the supply chain (f) has its initial value for the top level supplier f₁=d₁(credit line for the top level supplier)−e₁; thereafter for each lower level supplier f₂=f₁−e_{z}, . . . , fₙ=fₙ₋₁−eₙ;

(4) interest charge from bank h=e×interest rate (in the above embodiment, assuming 7%);

(5) service charge from bank i=(b+c)×service charge rate (in the above embodiment, assuming 7%);

(6) each supplier's balance j=e−g−h−i (g is bank loan approved for the supplier); and

(7) accumulated total business transaction turnover kₙ=bₙ+cₙ+kₙ₋₁.

### 5. Insurance Reserve Management System 5000

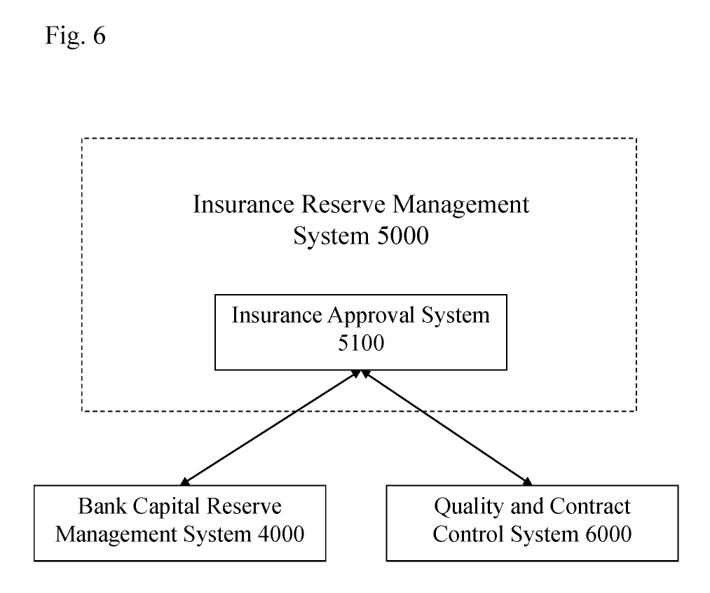

As shown in FIG. 6, an Insurance Reserve Management System 5000 is provided to determine the amount of insurance coverage to be issued to the suppliers in a supply chain business transaction according to the gross profit margin of each supplier in the supply chain business transaction, and to issue insurance approvals to the suppliers according to their gross profit margins in the supply chain business transaction.

In one embodiment, the Insurance Reserve Management System 5000 may communicate with the business transaction system in the Bank Capital Reserve Management System 4000, and may access and record the amount of sales order and purchase order (i.e. account receivable and account payable) for each of the suppliers in the supply chain business transaction. The Insurance Reserve Management System 5000 may record the amount of sales order and purchase order according to the interlocking contract for the supply chain business transaction, and may record the preset dates from the Quality and Contract Control System 6000.

In one embodiment, the Insurance Reserve Management System 5000 may include the Insurance Approval System 5100 to calculate the amount of insurance coverage to be approved to the suppliers according to their gross profit margin in the supply chain business transaction. In one embodiment, the Insurance Approval System 5100 may further calculate the insurance premium rate to be charged for the loan assurance according to a preset insurance premium rate or to a parameter from which insurance premium rate may be calculated from time to time. In one embodiment, the Insurance Reserve Management System 5000 may operate according to the following parameters, as shown in Table 5.1.

TABLE 5.1
one embodiment for the Bank Capital Reserve Management System 4000
Insurance Reserve Management System

| | | | | | | Insurance approval system | | |
|---|---|---|---|---|---|---|---|---|
| | | | | | | Standby | Gross Profit | Balance of |
| | | Business Transaction System | | | | insurance | Margin | insurance |
| | Supply chain | Date of | Buyer's | Sales | Purchase | coverage for | insurance | coverage in |
| | (including | time | purchase order | order | order | the entire | coverage for | the entire |
| | numbers of | assume | with confirmed | assume | assume | supply chain | each supplier | supply chain |
| Level | contract chains) | April | letter of credit | a | b | c | d = a − b | d |
| | Buyer's purchase | 1 | 1000 | | | 1000 | | |
| | order (1,000k) | | | | | | | |
| 1 | Supplier A | 1 | | 1000 | 650 | | 350 | 650 |
| 2 | Supplier B | 3 | | 650 | 490 | | 160 | 490 |
| 3 | Supplier C | 5 | | 490 | 390 | | 100 | 390 |
| 4 | Supplier D | 7 | | 390 | 0 | | 390 | 0 |
| | Total amount for | | 1000 | 2530 | 1530 | 1000 | 1000 | 0 |
| | supply chain | | | | | | | |

It is to be understood that following correlations further exist in the Insurance Reserve Management System 5000:

(1) a supplier's purchase order amount (b) equals to the sales order amount (a) of supplier of a lower level bₙ=aₙ₋₁;

(2) gross profit margin insurance coverage for a supplier d=a−b;

(3) balance of insurance coverage e=b.

### 6. Supply ChainLife Cycle Operation System 0001

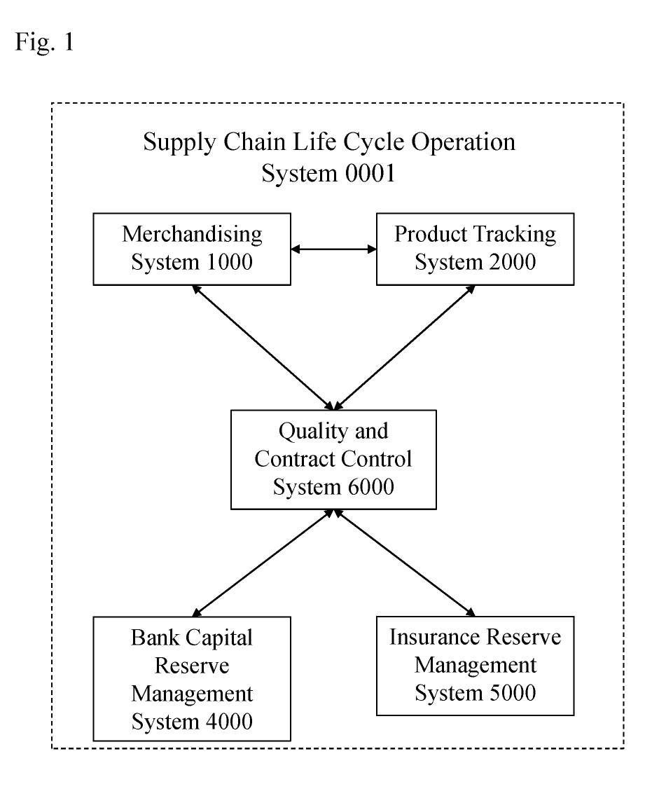

As shown in FIG. 1, a Supply Chain Life Cycle Operation System 0001 is provided to be a supply chain business transaction management and operation system. In one embodiment, the Supply Chain Life Cycle Operation System 0001 may include the Merchandising System 1000, the Product Tracking System 2000, the Quality and Contract Control System 6000, the Bank Capital Reserve Management System 4000 and the Insurance Reserve Management System 5000. In one embodiment, the Supply Chain Life Cycle Operation System 0001 may be configured to operate in order to form a life cycle operation of a supply chain business transaction.

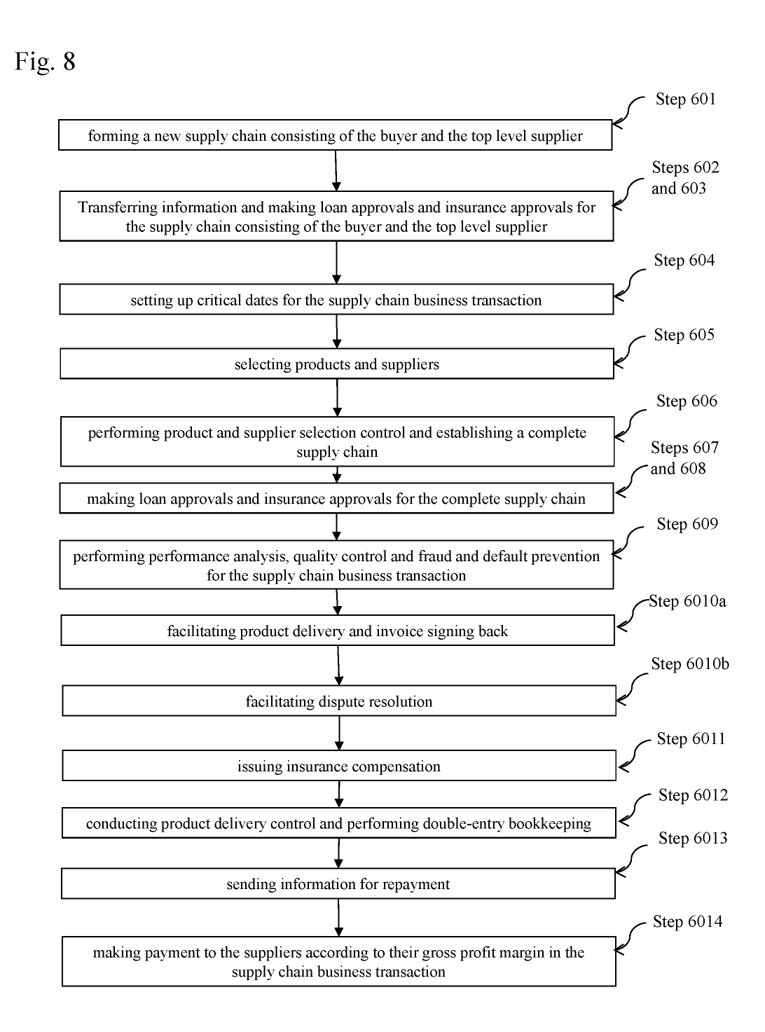

As further illustrated in FIG. 8, in one embodiment several steps are provided to operate the Supply Chain Life Cycle Operation System 0001, which may include:

Step 601 (forming a new supply chain consisting of the buyer and the top level supplier for the supply chain business transaction):
601.1. analyze if buyer's purchase order is real and the buyer's capability of business transaction as well a stop level supplier's ability for product production and delivery;
601.2. communicate with the Subsystem 1 for Preventing Counterfeiting and Money Laundering 6210 of the Quality and Contract Control System 6000, and use the Contract Condition Evaluation Calculator 6211 and Contract Authentication Calculator 6212;
601.3. input contract information, product item number, confirmed letter of credit, and other relevant information;
601.4. calculate the score for the estimate of the productivity of the contract, and move to next steps if the score passes a preset threshold;
601.5. evaluate the top level supplier's productivity, by averaging last two historical records;
601.6. examine the authenticity of the contract by conducting product matching;
601.7. communicate with Bank Capital Reserve Management System 4000, and input buyer's purchase orders amount into the Bank Capital Reserve Management System 4000; and
601.8. establish a new supply chain of it and commit to arrange guarantee payment to top level supplier in the supply chain if Steps 601.1 to 601.7 are carries out successfully, and send out a Pass signal from the Alert System 6300; or reject to establish a supply chain for the buyer or the top level supplier if Steps 601.1 to 601.7 are not carried out successfully, and send out a No signal from the Alert System 6300.

Step 602 (transferring the information of the supply chain consisting of the buyer and the top level supplier for loan approval and insurance approval)
602.1. send relevant information including contract, the score for the estimate of the productivity of the contract and the related guaranteed payment document (e.g. guaranteed letter of credit, etc.) to the Bank Capital Reserve Management System 4000 for verification of credit line approval and the Insurance Reserve Management System 5000 for the commitment of insurance coverage approval for all suppliers in the supply chain consisting of the buyer and the top level supplier.

Step 603 (making loan approvals and insurance approvals for the supply chain consisting of the buyer and the top level supplier)
603.1. verify the information for loan and insurance approvals received by the Bank Capital Reserve Management System 4000 and the Insurance Reserve Management System 5000;
603.2. determine loan approval requests for the buyer or the top level supplier and insurance coverage for the buyer or the top level supplier according to the guaranteed payment document (e.g. confirmed letter of credit) based on the total gross profit margins (which equals to the amount of the buyer's purchase order) of all suppliers in the supply chain;
603.3. analyze buyer's capability of business transaction and top level supplier's ability of product production and delivery; and
603.4. issue loan approvals (standby credit line) and insurance approvals (standby insurance coverage) equal to the amount of the buyer's purchase order to all suppliers in the supply chain based on the total gross profit margins for the whole supply chain if Steps 603.1 to 603.3 are carried out successfully, and send out a Pass signal from the Alert System 6300; or reject to approve loan and insurance requests if Steps 603.1 to 603.3 are not carried out successfully, and send out a No signal from the Alert System 6300.
603.5. communicate with the Subsystem 2 for Establishing Interlocking Contract 6220 of the Quality and Contract Control System 6000;

Step 604 (setting up critical dates for the supply chain business transaction)
604.1. produce the Product Tracking Report 1030 in the Product Tracking System 2000 for each supplier and input current status into the Product Tracking Report 1030;
604.2. communicate with the Supply Chain Production Lead Time Calculator 6110 and Preset Supply Chain Alert Due Date Calculator 6120 of the Bank Checklist System 6100 in the Quality and Contract Control System 6000
604.3. input relevant information of the contract such as shipment date, payment date, etc.;
604.4. calculate the production time, number of days for repayment etc.;
604.5. calculate preset alert due date for each production and control period;
604.6. conduct regular check and due date check by the Alert System 6300; and
604.7. import critical date information into the Quality and Contract Control System 6000.

Step 605 (selecting products and suppliers for the supply chain business transaction)
605.1. provide the facilities in the Supply Chain Mall 1020 in the Merchandizing System 1000 for each supplier to purchase material in order to standardize the contract for speeding up confirmation and signing of contract among the suppliers on the Electronic Contract Signing Platform 1040 in the Merchandising System 1000;
605.2. transfer contract data into information in the e-Manufacturing Sheet 1010 in the Merchandising System 1000;
605.3. shop around in Supply Chain Mall 1020 to select and compare products and suppliers for the contract, using the e-procurement planning process for cost estimation and budgeting purposes;
605.4. convert updated information from Supply Chain Mall 1020 into e-Manufacturing Sheet 1010;
605.5. form interlocking contract when materials, products and suppliers are selected;
605.6. identify contracts for their authenticity, to prevent fraud or money laundering;
605.7. perform the quality control of materials by matching the product item number assigned by the Supply Chain Mall 1020 for each product to reduce counterfeit and inferior production.

Step 606 (performing product and supplier selection control and establishing a complete supply chain of the supply chain business transaction)
606.1. analyze if interlocking contract is real and all suppliers' ability of product production and delivery;
606.2. communicate with the Subsystem 1 for Preventing Counterfeiting and Money Laundering 6210 of the Quality and Contract Quality Control System 6000, use the Contract Condition Evaluation Calculator 6211 and Contract Authentication Calculator 6212;
606.3. input contract information, product item number, confirmed letter of credit, and other relevant information;
606.4. calculate the score for the estimate of the productivity of the interlocking contract;
606.5. move to next steps if the score passes a preset threshold;
606.6. evaluate all suppliers' productivity by averaging last two historical records;
606.7. examine the authenticity of the interlocking contract by conducting product matching;
606.8. communicate with Bank Capital Reserve Management System 4000, and input purchaser's purchase order's amount into the Bank Capital Reserve Management System 4000;
606.9. provide loan approvals for all the suppliers in the interlocking contracts according to their gross profit margins in the supply chain;
606.10. establish a complete supply chain for all the suppliers and commits to guarantee payment to all suppliers in the supply chain if Steps 606.1 to 606.9 are carries out successfully, and send out a Pass signal from the Alert System 6300; or reject to extend a supply chain for the purchasers if Steps 606.1 to 606.9 are not carried out successfully, and send out a No signal from the Alert System 6300.

Step 607 (transferring the information of the complete supply chain of the supply chain business transaction for loan approval and insurance approval)
607.1. send relevant information including interlocking contract, the score for the estimate of the productivity of the contract and the related guaranteed payment document (e.g. guaranteed letter of credit, etc.) to the Bank Capital Reserve Management System 4000 for verification of gross profit margin loan approval and the Insurance Reserve Management System 5000 for the gross profit margin insurance of insurance coverage approval for all the suppliers in the supply chain.

Step 608 (making loan approvals and insurance approvals for the complete supply chain of the supply chain business transaction)
608.1. verify the information for loan and insurance approvals received by the Bank Capital Reserve Management System 4000 and the Insurance Reserve Management System 5000;
608.2. determine loan approval requests for the entire supply chain and insurance coverage for the entire supply chain according to the guaranteed payment document (e.g. confirmed letter of credit) based on the gross profit margins of the participants in the supply chain
608.3. analyze purchaser's capability of business transaction and suppliers' ability of product production and delivery;
608.4. issue loan approvals and insurance approvals for all suppliers in the supply chain based on their gross profit margins if Steps 608.1 to 608.3 are carries out successfully, and send out a Pass signal from the Alert System 6300; or reject to approve loan and insurance requests if Steps 608.1 to 608.3 are not carried out successfully, and send out a No signal from the Alert System 6300.

Step 609 (performing performance analysis, quality control and fraud and default prevention for the supply chain business transaction)
609.1. analyze the progress of contract fulfillment of the suppliers in order to monitor product production and delivery, and update the Product Tracking Report 1030;
609.2. ensure the quality of materials used in production process meet the specifications in the e-Manufacturing Sheet 1010, to enhance product quality and prevent counterfeit or inferior products;
609.3. number all confirmed shipping document, and require suppliers to fill in the shipping document number of the suppliers from one level below in a supply chain to form a tow, to ensure the goods is correct and to prevent false bills of lading, fake invoices, packing lists and other risks that often appear;
609.4. monitor the progress of production using the Subsystem 3 for Monitoring Progress of Production 6230 of the Quality and Contract Control System 6000;
609.5. regularly check products on due dates to alert both purchasers and suppliers for the possible delay;
609.6. input material data and product data into e-Consumption Account 2300 in the Product Tracking System 2000;
609.7. if there are complaints, send complaints to supplier using the Subsystem 5 for Product Quality Control Feedback 6250 if products do not meet specification to further resolution, and send out a No signal from the Alert System 6300; if there are no complaints, send out a Pass signal from the Alert System 6300.

Step 6010a (facilitating product delivery and invoice signing back for the supply chain business transaction)
6010a.1. if Step 609 shows Pass signal, provide the facilities for each supplier the standardized invoice and packing list to streamline the operation of product tracking;
6010a.2. identify invoice for authenticity by examining the product consumed in the supply chain and matching the information in the e-Consumption Account 2300, to eliminate collusion between purchasers and suppliers to conduct joint fraud by issuing fake invoices;
6010a.3. communicate with the Subsystem 4 for Product Delivery Control 6240 of the Quality and Contract Control System 6000;
6010a.4. check on the due dates to see if packing list has been output, and regularly check product on due dates to alert both purchasers and suppliers to sign back invoice for payment;
6010a.5. output e-Packaging List 2400 from e-Consumption Account 2300 for the suppliers in the Product Tracking System 2000;
6010a.6. send standardized invoice with data to the purchaser;
6010a.7. if there are complaints, send complaints to supplier using the Subsystem 5 for Product Quality Control Feedback 6250 if products do not meet specification to further resolution, and send out a No signal from the Alert System 6300; if there are no complaints, end out a Pass signal from the Alert System 6300.

Step 6010b (facilitating dispute resolution for the supply chain business transaction)
6010b.1. if Step 609 shows No signal, send analysis report to insurance company to request for compensation;
6010b.2. choose alternate suppliers with sufficient stock, good delivery capabilities and records from the Supply Chain Mall 1020 as backup for the supply chain business transaction.

Step 6011 (issuing insurance compensation for the supply chain business transaction)
6011.1. following Step 6010b, makes verification for the compensation by the insurance company;
6011.2. send compensation agreement by the insurance company if information is verified and compensation request is approved;
6011.3. issue insurance compensation for affected parties related to the supply chain business transaction other than the supplier(s) who is/are at fault;
6011.4. check if insurance compensation is approved or not by due date by the Insurance Reserve Management System 5000.

Step 6012 (conducting product delivery control and performing double-entry bookkeeping for the supply chain business transaction)
6012.1. following Step 6010a, analyze if it is an effective interlocking receivable;
6012.2. number all confirmed shipping document, and request suppliers to fill in the shipping document number of the suppliers from one level below in a supply chain to form a tow, to help tracking where the raw materials come from and to ensure the goods is correct. If invoice is related to top level buyer directly or indirectly in the supply chain, it is an effective interlocking receivable;
6012.3. communicate with the Subsystem 6 for Gross Profit Margin Payment and Repayment 6260 of the Quality and Contract Control System 6000;
6012.4. check on the due date to see if signed invoice is converted into interlocking invoice;
6012.5. issue gross profit margin payment for suppliers and repayment to loan issuing agency using the Bank Capital Reserve Management System 4000;
6012.6. perform double entry-booking by the loan issuing agency using the Bank Capital Reserve Management System 4000.

Step 6013 (sending information for repayment for the supply chain business transaction)
6013.1. send relevant information to loan issuing agency for gross profit margin payment;
6013.2. perform double-entrybooking by the loan issuing agency and to net-off on its balance sheet.

Step 6014 (making payment to the suppliers according to their gross profit margin in the supply chain business transaction)
6014.1. make payment which equals to gross margin of each supplier by the loan issuing agency using the Bank Capital Reserve Management System 4000 when the buyer makes payment;
6014.2. check if the buyer makes payment and the suppliers get payment or not by the Bank Capital Reserve Management System 4000.

### 7. IT Security Protection System 7000

In one embodiment, an IT Security Protection System 7000 may be system to provide data encryption and security in storage and transmission of data over the Internet, through wireless communication including infrared communication, Bluetooth communication, NFC communication, and other means of communication over which the security of data may be breached. In one embodiment, the IT Security Protection System 7000 may be operate in connection with the Supply Chain Life Cycle Operation System 0001 to ensure that the data acquired, processed and transmitted in the Supply Chain Life Cycle Operation System 0001 is secured and is accessible only upon authorization by the.

In one embodiment, the IT Security Protection System 7000 may be configured to separate Supply Chain Life Cycle Operation System's 0001 network from public Internet by setting up firewalls, using strong user authentication mechanisms, providing web content filtering and other means the purposes of which are to protect internal servers of the Supply Chain Life Cycle Operation System 0001 from attacks coming from outside of the internal servers.

In one embodiment, the IT Security Protection System 7000 may be configured to enforce network infrastructure controls to ensure that unauthorized access or denial-of-service attacks can be detected, contained and recovered.

In one embodiment, the IT Security Protection System 7000 may be configured to use anti-virus software and intrusion detection and prevention systems to spot and stop malicious code or unauthorized access attempts.

In one embodiment, the IT Security Protection System 7000 may be configured to deploy and enforce strong user authentication mechanism, password policies and access control mechanisms to identify authorized users so as to protect data from unauthorized access.

In one embodiment, the IT Security Protection System 7000 may be configured to encrypt sensitive data and related transmission.

In one embodiment, the IT Security Protection System 7000 may be configured to keep data server and application server behind firewalls, within safely protected intranet network, which will not be directly accessible from public;

In one embodiment, the IT Security Protection System 7000 may be configured to forbid web servers from keeping important data as cookies or in other format, and to send requests to and receive data from internal servers (e.g. the data server and the application server) which are kept behind firewalls.

In one embodiment, the IT Security Protection System 7000 may be configured to conduct regular data security and integrity maintenance and backup. Data backup may be conducted regularly and the backed up data may be kept offsite, with a copy to fall back on in case of data loss. In one embodiment, contingency and disaster recovery planning may be in place to keep the business running in case of emergency. In another embodiment, confidential and sensitive data may be kept out from public web servers to guard against unauthorized access or modification.

A number of embodiments of the invention have been described. Nevertheless, it will be understood that various modifications may be made without departing from the spirit and scope of the invention. Accordingly, other embodiments are within the scope of the following claims.

1. A system for life cycle operation of a supply chain business transaction, comprising:
a recording and storage unit configured to record and store information regarding participants and products in the supply chain business transaction;
a recording and tracking unit configured to record and track products produced and consumed in the supply chain business transaction;
a monitoring unit configured to monitor contract performance and quality of products in the supply chain business transaction;
a loan credit determination unit configured to determine the amount of loan credit to be issued to the suppliers in the supply chain business transaction according to the gross profit margin of each supplier in the supply chain business transaction, and issue loan approvals to the suppliers according to their gross profit margins in the supply chain business transaction; and
an insurance coverage determination unit configured to determine the amount of insurance coverage to be issued to suppliers in the supply chain business transaction according to the gross profit margin of each supplier in the supply chain business transaction, and issue insurance approvals to the suppliers according to their gross profit margins in the supply chain business transaction.

2. The system claim 1, further comprising a data encryption and security system configured to provide data encryption and security in storage and transmission of data.

3. The system of claim 1, wherein the recording and storage unit includes:
a supply chain mall, configured to:
acquire and store information regarding participants and products relevant to the supply chain business transaction, and
recommend participants and products for the supply chain business transaction;
wherein the supply chain mall comprises: a merchandise system database to store information regarding participants and products relevant to the supply chain business transaction
an e-manufacturing sheet, configured to:
convert information regarding the supply chain business transaction,
access the merchandise system database to store information relevant to the supply chain business transaction,
conduct e-manufacturing planning to selected participants and products for the supply chain business transaction,
place orders for the supply chain business transaction and conclude contracts for all levels of the supply chain, and
convert contracts for all levels of the supply chain into an interlocking contract; and
an electronic contract signing platform configured to adopt and prepare contracts to be used in the supply chain business transactions.

4. The system of claim 3, wherein the e-manufacturing sheet comprises:
converting data relevant to the supply chain business transaction acquired from the supply chain mall to data in the e-manufacturing sheet;
acquiring information reviewed and proofread by the suppliers in the supply chain business transaction;
comparing the information from different product-supplier selections according to different factors and combinations; and
placing orders directly when the e-manufacturing sheet concludes the procurement data comparison and makes selection of products and suppliers.

5. A method for life cycle operation of a supply chain business transaction, comprising:
forming a new supply chain consisting of the buyer and the top level supplier for the supply chain business transaction;
transferring the information of the supply chain consisting of the buyer and the top level supplier for loan approval and insurance approval, and making loan approvals and insurance approvals for the supply chain consisting of the buyer and the top level supplier;
setting up critical dates for the supply chain business transaction;
selecting products and suppliers for the supply chain business transaction;
performing product and supplier selection control and establishing a complete supply chain of the supply chain business transaction;
transferring the information of the complete supply chain of the supply chain business transaction for loan approval and insurance approval, and making loan approvals and insurance approvals for the complete supply chain of the supply chain business transaction;
performing performance analysis, quality control and fraud and default prevention for the supply chain business transaction;
facilitating product delivery and invoice signing back for the supply chain business transaction;
facilitating dispute resolution for the supply chain business transaction;
issuing insurance compensation for the supply chain business transaction;
conducting product delivery control and performing double-entry bookkeeping for the supply chain business transaction;
sending information for repayment for the supply chain business transaction; and
making payment to the suppliers according to their gross profit margin in the supply chain business transaction.

6. The method of claim 5, further comprising
initializing the supply chain business transaction by conducting the following:
analyzing whether a purchaser's purchase order is real and the buyer's capability of business transaction as well as a top level supplier's ability to product production and delivery,
inputting contract information, product item number, confirmed letter of credit, and other relevant information,
calculating a score for the estimate of the productivity of the contract, and moving to next steps if the score passes a preset threshold,
evaluating the top level supplier's productivity by averaging historical records,
examining the authenticity of the contract by conducting product matching,
inputting the purchaser's purchase order amount,
providing loan standby approvals for all suppliers including the top level supplier according to its total gross profit margin in the supply chain,
establishing a supply chain and committing to guarantee payment to all suppliers including the top level supplier in the supply chain, and
sending out a pass signal if above steps are carried out successfully; if not, sending out a no signal to reject to establish a supply chain;
following the pass signal by conducting the following:
sending relevant information for verification of standby credit line approval and for the commitment of insurance coverage approval for all suppliers including the top level supplier,
verifying the information for loan and insurance approval requests,
determining the loan approval requests for the top level supplier and insurance coverage for the top level supplier according to the guaranteed payment document based on the gross profit margin of the top level supplier in the supply chain,
analyzing the buyer's capability of business transaction and the top level supplier's ability of product production and delivery, and
issuing loan approvals and insurance approvals for all suppliers including the top level supplier in the supply chain based on its total gross profit margins and sending out a pass signal if above steps are carried out successfully; if not, sending out a no signal to reject to approve loan and insurance requests;
following the pass signal by conducting the following:
producing a product tracking report for each supplier and inputting relevant information into the product tracking report,
calculating production and control periods for the supply chain business transaction,
calculating preset alert due date for each production and control period,
conducting regular checks and due date checks,
providing facilities for each supplier to purchase material for standardizing the contract,
selecting and comparing products and suppliers for the contract according to cost estimation and budgeting purposes,
forming an interlocking contract when materials, products and suppliers are selected,
identifying contracts for authenticity to prevent fraud or money laundering,
performing quality control of materials by matching the product item number for each product,
analyzing if the interlocking contract is real and all suppliers' ability to product production and delivery,
inputting contract information, product item number, confirmed letter of credit, and other relevant information,
calculating the score for estimate of the productivity of the interlocking contract,
moving to next steps if the score for estimate of the productivity of the interlocking contract passes a preset threshold,
evaluating all suppliers' productivity by averaging last historical records,
examining the authenticity of the interlocking contract by conducting product matching,
providing loan approvals for all the suppliers in the interlocking contract according to their gross profit margins in the supply chain, and
sending out a pass signal to establish a complete supply chain for all the suppliers and commit to guarantee payment to all suppliers in the supply chain if above steps carries out successfully; if not, or sending out a no signal reject to establish a supply chain for the purchasers;
following the pass signal by conducting the following:
sending relevant information including interlocking contract, the score for the estimate of the productivity of the contract and the related guaranteed payment document for verification of credit line approval and for commitment of insurance coverage approval for all the suppliers in the supply chain,
verifying the information for loan and insurance approvals,
determining the loan approval requests for the entire supply chain and insurance coverage for the entire supply according to the guaranteed payment document based on the gross profit margins of the participants in the supply chain,
analyzing the purchaser's capability of business transaction and the suppliers' ability of product production and delivery, and
sending out a pass signal to issue loan approvals and insurance approvals for all suppliers in the supply chain based on their gross profit margins if above steps are carries out successfully; if not, sending out a no signal reject to approve loan and insurance requests;
following the pass signal by conducting the following:
analyzing progress of contract fulfillment of the suppliers in to monitor product production and delivery,
ensuring the quality of materials used in production process meet specifications,
numbering confirmed shipping document, and requiring the suppliers to fill in the shipping document number of the suppliers from one level below in a supply chain to form a tow,
monitoring the progress of production,
checking products regularly on due dates to alert both the purchasers and the suppliers for possible delay, and
sending a no signal and sending complaints to further resolution, if there are complaints, to the suppliers if the products do not meet specification; if not, sending out a pass signal;
following the no signal by conducting the following:
sending analysis report to insurance company to request for compensation,
choosing alternate suppliers with sufficient stock, good delivery capabilities and records as backup for the supply chain business transaction,
making verification for compensation by the insurance company,
sending compensation agreement by the insurance company if information is verified and the compensation request is approved,
issuing insurance compensation for affected parties to the supply chain business transaction other than the suppliers at fault, and
checking if insurance compensation is approved or not by due date;
following a pass signal by conducting the following:
providing facilities for each supplier the standardized invoice and the packing list to streamline operation of product tracking,
identifying the invoices for authenticity by examining the product consumed in the supply chain and matching information,
checking on the due date to see if packing list has been output, and regularly checking product on due dates to alert both the purchasers and the suppliers to sign back invoices for payment,
outputting e-packaging list for the suppliers,
sending standardized invoice with data to the purchasers, and
sending a no signal and sending complaints to further resolution, if there are complaints, to the suppliers if the products do not meet specification; if not, sending out a pass signal; and
following a pass signal by conducting the following:
analyze if it is an effective interlocking receivable,
numbering all confirmed shipping document, and requesting suppliers to fill in the shipping document number of the suppliers from one level below in a supply chain to form a tow,
checking on the due date to see if signed invoice is converted into interlocking invoice,
issue gross profit margin payment for suppliers and repayment to loan issuing agency,
performing double-entry bookkeeping by the loan issuing agency,
sending relevant info to the loan issuing agency for gross profit margin payment,
performing double-entry bookkeeping by the loan issuing agency and net-off on its balance sheet,
making payment equals to gross margin of each supplier by the loan issuing agency when the buyer makes payment, and
checking if the buyer makes payment and supplier get payment or not.

7. The system of claim 1, wherein the recording and tracking unit includes:
a supply chain feedback system, configured to:
collect feedback information in the supply chain,
notify relevant participants in the supply chain business transaction, and
facilitate dispute resolution; and
an e-consumption account and an e-packaging list, configured to:
record the data of product movement and consumption in the supply chain,
control products used in production in all the levels in the supply chain business transaction,
monitor products consumed and products produced in the supply chain,
associate invoices from different levels of the supply chain,
perform routine checks on the transaction records of the supply chain business transaction, and
detect potential fraud or defaults.

8. A monitoring unit for monitoring contract performance and quality of products in a supply chain business transaction, comprising:
a bank checklist subunit configured to calculate the critical dates in the supply chain business transaction for quality and contract performance control purposes;
a control fraud and default checking subunit configured to perform quality and contract control to prevent fraud and default in the supply chain business transaction; and
an alert subunit to send out alert signals to participants in the supply chain business transaction.

9. The monitoring unit of claim 8, wherein the bank checklist subunit comprises:
a supply chain production lead time calculator to calculate production lead time for the supply chain business transaction, and
a preset supply chain alert due date calculator to calculate alert dates for the supply chain business transaction.

10. The monitoring unit of claim 8, wherein the control fraud and default checking subunit comprises:
a counterfeiting and money laundering prevention module configured to prevent counterfeiting and money laundering in the supply chain business transaction,
an interlocking contract establishment module configured to establish interlocking contract for the supply chain business transaction,
a progress of production monitoring module configured to monitor the progress of production for the supply chain business transaction,
a product delivery control module configured to control product delivery for the supply chain business transaction,
a product quality control feedback module configured to control product quality for the supply chain business transaction,
a gross profit margin payment and repayment module configured to ensure payment and repayment in the supply chain business transaction according to suppliers' gross profit margin, and
an overfunding and overpurchasing prevention module configured to prevent overfunding and overpurchasing in the supply chain business transaction.

11. The monitoring unit of claim 10, wherein the counterfeiting and money laundering prevention module comprises:
a contract condition evaluation calculator configured to examine and check for credit allowances and allocation among the suppliers in the supply chain, and
a contract authentication calculator configured to match products in the supply chain business transaction.

12. A system for managing bank credit reserve and insurance reserve, comprising:
a bank credit reserve management unit configured to determine an amount of loan credit to be issued to the suppliers in a supply chain business transaction according to the gross profit margin of each supplier in the supply chain business transaction, and issuing loan approvals to the suppliers according to their gross profit margins in the supply chain business transaction; and
an insurance reserve management unit configured to determine an amount of insurance coverage to be issued to suppliers in the supply chain business transaction according to the gross profit margin of each supplier in the supply chain business transaction, and issuing insurance approvals to the suppliers according to their gross profit margins in the supply chain business transaction.

13. The system for managing bank credit reserve and insurance reserve of claim 12, wherein the bank credit reserve management unit comprises:
a business transaction module configured to calculate the amount of account receivable and account payable for each supplier in the supply chain business transaction;
a loan approval module configured to calculate the amount of loan to be approved to the suppliers according to each supplier's gross profit margin in the supply chain business transaction; and
a productivity lending module to calculate the total business turnover and the business turnover rate in the supply chain business transaction;
wherein the bank credit reserve management unit is configured to:
contact with a purchaser's bank for repayment on a preset determined payment date according to an interlocking contract for the supply chain business transaction;
perform net-off calculation and use the result as a basis for the interlocking contract and an interlocking invoice in double-entry bookkeeping; and
collect the whole payment amount from the buyer and distribute the payment to every supplier according to the gross profit margin.

14. The system for managing bank credit reserve and insurance reserve of claim 12, wherein the insurance reserve management unit comprises: an insurance approval module to calculate the amount and the rate of insurance coverage to be approved to the suppliers according to their gross profit margin in the supply chain business transaction.
